(19) United States
(12) Patent Application Publication
(10) Pub. No.: US 2024/0192618 A1
(43) Pub. Date: Jun. 13, 2024

(54) TONER FOR ELECTROPHOTOGRAPHY OR ELECTROSTATIC RECORDING

(71) Applicant: CANON KABUSHIKI KAISHA, Tokyo (JP)

(72) Inventors: YUKI MASUDA, Shizuoka (JP); KENJI AOKI, Shizuoka (JP); NAOYA ISONO, Shizuoka (JP); MARIKO YAMASHITA, Shizuoka (JP); TATSUYA SAEKI, Shizuoka (JP); MEGUMI MORIYA, Shizuoka (JP)

(21) Appl. No.: 18/516,201

(22) Filed: Nov. 21, 2023

(30) Foreign Application Priority Data
Nov. 29, 2022 (JP) 2022-189767

(51) Int. Cl. G03G 9/087; G03G 9/08

(52) U.S. Cl. CPC G03G 9/08711; G03G 9/0804; G03G 9/0817; G03G 9/0821

(57) ABSTRACT

The toner of the present disclosure comprises a toner particle containing a crystalline resin A, an amorphous resin B, and a release agent, wherein the resin A contains a specific amount of a unit (a) and is contained in a specific amount in the toner, the resin B is contained in a specific amount in the toner, the total content of the resin A and the resin B is 50.0 mass % or more based on the mass of the toner, when a component W having a molecular weight of 5000 or less is isolated from the toner by a certain procedure, the content of the component W is from 0.5 mass % to 20.0 mass % based on the mass of the toner, and the maximum endothermic peak temperature of the component W and the endothermic peak temperature derived from the component W of the toner satisfy a certain requirement.

### BACKGROUND

### Field of the Disclosure

The present disclosure relates to a toner that is used in electrophotography or an electrostatic recording method.

### Description of the Related Art

Energy saving has been considered a major technical challenge also in electrophotographic apparatuses, and a significant reduction in the heat quantity required by the fixing device has been studied. In particular, in a toner, there is a growing need for so-called “low-temperature fixability” that enables fixing with lower energy.

As a method for allowing fixing at low temperature, a method using a crystalline resin as the binder resin has been studied. An amorphous resin that is generally used as a binder resin for a toner does not show a clear endothermic peak in differential scanning calorimetry (DSC) measurement, but when a crystalline resin component is contained, an endothermic peak appears in DSC measurement.

A crystalline resin has a property of hardly softening until the endothermic peak temperature due to the regularly arranged side chains in the molecule. In addition, the crystal melts rapidly after reaching the endothermic peak temperature, and a sudden drop in the viscosity occurs associated with the melting. Accordingly, a crystalline resin is gathering attention as a material having an excellent sharp melt property and exhibiting low-temperature fixability.

As a toner using the crystalline resin, a toner using a crystalline vinyl resin having a long-chain alkyl group in a side chain of the molecule is exemplified. In general, a crystalline vinyl resin includes a long-chain alkyl group as a side chain in the main chain frame and becomes a crystalline resin by crystallization of the individual long-chain alkyl groups of the side chains. Japanese Patent Laid-Open No. 2014-142632 proposes a toner showing a sea-island structure constituted of a sea portion whose main component is a crystalline vinyl resin and an island portion whose main component is an amorphous resin. Japanese Patent Laid-Open No. 2022-96213 proposes a toner in which a release agent containing α-olefin monomer unit is added to a crystalline vinyl resin.

However, it was demonstrated that although the toners described in the above literatures satisfy low-temperature fixability, the hot-offset resistance and the bending resistance of a solid image (an image with a very high printing rate) after fixing are insufficient. This bending resistance is becoming one of more important characteristics with the wide spread of full color.

The toner described in Japanese Patent Laid-Open No. 2014-142632 uses a release agent familiar with a vinyl resin having a long-chain alkyl group that is a crystal component. It is inferred that the release agent remains in the inside during fixing, and thereby the mold releasing effect by the release agent decreases during high-temperature fixing, and thereby hot offset more easily occurs. In addition, it is inferred that when the solid image after fixing is bent, cracking and peeling occur due to the release agent inside the toner, and the bending resistance decreases.

In the toner described in Japanese Patent Laid-Open No. 2022-96213, the amount of the crystal component in the binder resin is large, and the viscosity decreases too much during high-temperature fixing. Accordingly, the hot-offset resistance becomes insufficient. In addition, it is inferred that cracking (cleavage) occurs along the direction of crystal of the crystalline resin, and thereby cracking and peeling occur when the solid image after fixing is bent, and the bending resistance decreases. From the above, further improvements are required to realize a toner that is excellent in low-temperature fixability and excellent in hot-offset resistance and the bending resistance of the solid image after fixing.

### SUMMARY

The present disclosure has been made in view of the above problems and provides a toner that is excellent in low-temperature fixability and excellent in hot-offset resistance and the bending resistance of the solid image after fixing.

The present disclosure relates to a toner comprising a toner particle containing a crystalline resin A, an amorphous resin B, and a release agent, wherein
the crystalline resin A contains 30.0 mass % or more of a unit (a) represented by a formula (1) below, and
the crystalline resin A is contained in an amount of 20.0 mass % or more and 80.0 mass % or less based on the mass of the toner;
the amorphous resin B is contained in an amount of 5.0 mass % or more and 80.0 mass % or less based on the mass of the toner;
the total content of the crystalline resin A and the amorphous resin B is 50.0 mass % or more based on the mass of the toner;
when the toner is dissolved in tetrahydrofuran to obtain a tetrahydrofuran-soluble matter, the obtained tetrahydrofuran-soluble matter is dissolved in n-hexane to obtain a n-hexane-soluble matter, the obtained n-hexane-soluble matter is subjected to gel permeation chromatography (GPC) to isolate a component having a molecular weight of 5000 or less, and the obtained component is designated as component W,
the content of the component W is 0.5 mass % or more and 20.0 mass % or less based on the mass of the toner; and
the peak temperature of the maximum endothermic peak of the component W is designated as TmW (° C.), and when the endothermic peak of the toner is measured, the temperature of the endothermic peak derived from the component W is designated as TmT (° C.),
the TmW and the TmT satisfy

50.0≤TmW≤85.0, and

−2.0≤TmW−TmT≤4.5

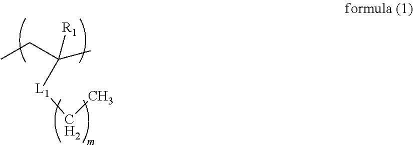

[in the formula (1), R₁ represents a hydrogen atom or a methyl group, L₁ represents a single bond, an ester bond, or an amide bond, and m represents an integer of 15 or more and 30 or less].

Further features of the present disclosure will become apparent from the following description of exemplary embodiments.

### DESCRIPTION OF THE EMBODIMENTS

In the present disclosure, the descriptions of “XX or more and YY or less” and “XX to YY” representing a numerical range mean a numerical range including the lower and upper limits that are endpoints, otherwise specified.

(Meth)acrylic acid ester means acrylic acid ester and/or methacrylic acid ester.

In stepwise numerical ranges described herein, the upper and lower limits of each numerical range can be arbitrarily combined.

The “monomer unit” refers to a reacted form of a monomer material in a polymer. For example, one section of a carbon-carbon bond in the main chain in which a polymerizable monomer in a polymer is polymerized is one unit. The polymerizable monomer can be represented by the following formula (C):

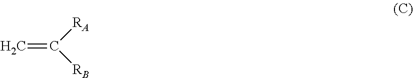

[in the formula (C), R_{A} represents a hydrogen atom or an alkyl group (which may be an alkyl group having 1 to 3 carbon atoms or a methyl group), and R_{B} represents an arbitrary substituent].

### Features of the Present Disclosure

The present inventors found that the above-mentioned problems in a toner using a crystalline resin can be solved by approximately controlling the contents of the crystalline resin and amorphous resin in the binder resin and further the compatibility between the binder resin and the release agent in the toner.

The present disclosure relates to a toner comprising a toner particle containing a crystalline resin A, an amorphous resin B, and a release agent, wherein
the crystalline resin A contains 30.0 mass % or more of a unit (a) represented by a formula (1) below, and
the crystalline resin A is contained in an amount of 20.0 mass % or more and 80.0 mass % or less based on the mass of the toner;
the amorphous resin B is contained in an amount of 5.0 mass % or more and 80.0 mass % or less based on the mass of the toner;
the total content of the crystalline resin A and the amorphous resin B is 50.0 mass % or more based on the mass of the toner;
when the toner is dissolved in tetrahydrofuran to obtain a tetrahydrofuran-soluble matter, the obtained tetrahydrofuran-soluble matter is dissolved in n-hexane to obtain a n-hexane-soluble matter, the obtained n-hexane-soluble matter is subjected to gel permeation chromatography (GPC) to isolate a component having a molecular weight of 5000 or less, and the obtained component is designated as component W,
the content of the component W is 0.5 mass % or more and 20.0 mass % or less based on the mass of the toner; and
the peak temperature of the maximum endothermic peak of the component W is designated as TmW (° C.), and when the endothermic peak of the toner is measured, the temperature of the endothermic peak derived from the component W is designated as TmT) (° C.),
the TmW and the TmT satisfy

50.0≤TmW≤85.0, and

−2.0≤TmW−TmT≤4.5,

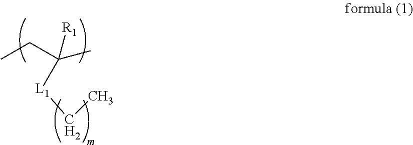

[in the formula (1), R₁ represents a hydrogen atom or a methyl group, L₁ represents a single bond, an ester bond, or
an amide bond, and m represents an integer of 15 or more and 30 or less].

In order to achieve both low-temperature fixability and hot-offset resistance, it is important that the release agent bleeds to the fixed image surface during fixing in a wide temperature range and that the viscosity does not decrease too much during high-temperature fixing while the toner has a sharp melt property.

The present inventors found that an improvement in the phase separation property between the binder resin and the release agent, a decrease in the “TmW−TmT” which is a parameter of a phase separation property, and a use of a predetermined amount of an amorphous resin in the toner improve the low-temperature fixability and hot-offset resistance and furthermore show an effect on the bending resistance of the solid fixed image.

Here, the “TmW−TmT” indicates the difference between the endothermic peak temperature of the release agent extracted from the toner and the endothermic peak temperature of the release agent in the toner. When the phase separation property between the release agent and the binder resin is high, melting of the release agent is unlikely to be affected by the binder resin, and the value of “TmW−TmT” becomes small.

The reasons why cracking and peeling occur when a solid fixed image is bent are thought to be (1) a release agent that causes cracking and so on remains inside the fixed image and (2) cleavage occurs due to a crystal component.

Regarding the above (1) that the release agent remains inside the fixed image, the release agent finely dispersed in the toner particle melts by the heat during fixing, and the melted release agent is cooled and solidifies on the surface or inside of the fixed image to form a large domain. If this large domain of the release agent is present inside the fixed image, when the fixed image is bent, this domain becomes a fracture surface to easily cause cracking and so on in the image. In order to prevent such a release agent from remaining inside the fixed image, it is necessary to create an enhanced phase separation property state between the release agent and the binder resin in the toner and to allow the release agent to promptly bleed to the fixed image surface during fixing.

Accordingly, the compatibility between the crystalline resin and the release agent during fixing can be prevented by adding an amorphous resin to the binder resin to cause entanglement of individual molecules of the amorphous resin, and the phase separation property between the release agent and the binder resin is enhanced. Accordingly, bleeding of the release agent to the fixed image surface is promoted when the amorphous resin is fixed, and the domain of the release agent is unlikely to remain inside the solid image after fixing.

Regarding the above (2) of cleavage by a crystal component, similarly, when the toner is cooled and solidifies after fixing, the crystalline component forms a large crystal in the fixed image, and thereby cracking and so on are likely to occur along the crystal when the image is bent. Since the amorphous resin has appropriate toughness due to a large amount of entanglement of individual molecules, an effect of suppressing the cleavage of the crystal component can also be expressed by adding an amorphous resin to the binder resin.

This mechanism can provide a toner of which the low-temperature fixability, the hot-offset resistance, and the bending resistance of the solid fixed image are all well.

Hereinafter, the toner of the present disclosure will be described in detail.

The toner of the present disclosure contains a crystalline resin A. The crystalline resin A is a resin including a unit (a) represented a formula (1):

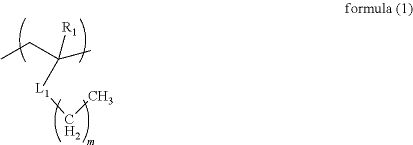

[in the formula (1), R₁ represents a hydrogen atom or a methyl group, L₁ represents a single bond, an ester bond, or an amide bond, and m represents an integer of 15 or more and 30 or less].

The formula (1) shows that the unit (a) includes a long-chain alkyl group, and the resin has crystallinity by including the long-chain alkyl group.

When m in the formula (1) is within a range of 15 or more and 30 or less, a toner excellent in the low-temperature fixability can be obtained, and m may be 18 or more and 24 or less.

Examples of the method for introducing the unit (a) into the crystalline resin A include a method by adding a monomer, such as α-olefin, β-olefin, (meth)acrylic acid ester, or N-alkylacrylamide having a long-chain alkyl group, during vinyl polymerization.

In particular, from the easiness of controlling the physical properties, such as the SP value and the endothermic peak temperature, of the crystalline resin A, the crystalline resin A may include a unit represented by a formula (a-A):

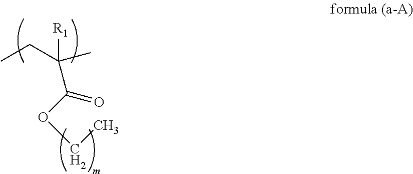

[in the formula (a-A), R₁ represents a hydrogen atom or a methyl group, and m represents an integer of 15 or more and 30 or less].

Examples of the method for introducing the unit represented by the formula (a-A) into the crystalline resin A include a method by adding (meth)acrylic acid ester such as those exemplified below during vinyl polymerization.

Specifically, the (meth)acrylic acid ester is a monomer such as stearyl (meth)acrylate, nonadecyl (meth)acrylate, eicosyl (meth)acrylate, heneicosanyl (meth)acrylate, behenyl (meth)acrylate, lignoceryl (meth)acrylate, ceryl (meth)acrylate, octacosa (meth)acrylate, myricyl (meth)acrylate, dodriaconta (meth)acrylate, or 2-decyltetradecyl (meth)acrylate.

The proportion of the unit (a) in the crystalline resin A is 30.0 mass % or more and 100 mass % or less. When the proportion of the unit (a) is less than 30.0 mass %, the amount of the crystal component is small, and the low-temperature fixability deteriorates.

The upper limit of the proportion range of the unit (a) can be 90.0 mass % or less. The lower limit can be 50.0 mass % or more and may be 60.0 mass % or more or 70.0 mass % or more.

The content proportion of the crystalline resin A in the toner of the present disclosure is 20.0 mass % or more and 80.0 mass % or less based on the mass of the toner.

When the content proportion of the crystalline resin A is less than 20.0 mass %, the amount of the crystal component is small, and the low-temperature fixability deteriorates. In a toner in which the content proportion of the crystalline resin A exceeds 80.0 mass %, the viscosity of the toner decreases during high-temperature fixing, and the hot-offset resistance deteriorates.

The lower limit of the content proportion range of the crystalline resin A can be 25.0 mass % or more. The upper limit can be 60.0 mass % or less and may be 50.0 mass % or less or 40.0 mass % or less.

The toner of the present disclosure contains an amorphous resin B, in addition to the crystalline resin A.

The content proportion of the amorphous resin B in the toner of the present disclosure is 5.0 mass % or more and 80.0 mass % or less based on the mass of the toner.

When the content proportion of the amorphous resin B is less than 5.0 mass %, the proportion of the crystal component is high, cleavage cannot be suppressed, and solid image fixability decreases. In a toner in which the content proportion of the amorphous resin B exceeds 80.0 mass %, the proportion of the crystal component is low, and the low-temperature fixability decreases.

The lower limit of the content proportion range of the amorphous resin B can be 10.0 mass % or more and may be 30.0 mass % or more or 40.0 mass % or more. The upper limit can be 65.0 mass % or less.

The total content proportion of the crystalline resin A and the amorphous resin B in the toner of the present disclosure is 50.0 mass % or more based on the mass of the toner.

When the total content proportion of the crystalline resin A and the amorphous resin B is less than 50.0 mass %, the amount of the binder resin is small, the toner becomes difficult to adhere to paper during fixing, and the bending resistance decreases.

The component W in the present disclosure is a component obtained by dissolving a toner in tetrahydrofuran to obtain a tetrahydrofuran-soluble matter, dissolving the obtained tetrahydrofuran-soluble matter in n-hexane to obtain a n-hexane-soluble matter, and subjecting the obtained n-hexane-soluble matter to gel permeation chromatography (GPC) to isolate a component having a molecular weight of 5000 or less.

Since the component W is a component that is dissolved in hexane and has low polarity, the main component thereof is the release agent.

The content proportion of the component W in the toner of the present disclosure is 0.5 mass % or more and 20.0 mass % or less based on the mass of the toner.

When the content proportion of the component W is less than 0.5 mass %, the mold releasing effect during fixing is low, and the hot-offset resistance decreases. When the content proportion of the component W is greater than 20.0 mass %, the component W remains in the inside during fixing, and the bending resistance of the solid image decreases due to the component W.

The lower limit of the range of the component W can be 2.0 mass % or more and may be 5.0 mass % or more. The upper limit can be 16.0 mass % or less.

In the toner of the present disclosure, the peak temperature of the maximum endothermic peak of the component W is designated as TmW (° C.). And when the endothermic peak of the toner is measured, the temperature of the endothermic peak derived from the component W is designated as TmT (° C.).
The TmW and the TmT satisfy

50.0≤TmW≤85.0, and

−2.0≤TmW−TmT≤4.5.

When the endothermic peak of a toner is measured, there is a risk of changing the compatible state in the toner by receiving a thermal history. Accordingly, the measurement result of the first temperature increase process is used in DSC measurement. When the endothermic peak of the component W is measured, there is a risk of changing the crystal state in the operation of extracting the component W from the toner. Accordingly, the measurement result of the second temperature increase process is used in DSC measurement.

When the TmW is less than 50.0° C., the component W is more easily compatible with the binder resin, and the hot-offset resistance decreases. When the TmW is higher than 85.0° C., the mold releasing effect during low-temperature fixing is low, and the low-temperature fixability decreases.

The TmW may be 65.0° C. or more and 80.0° C. or less.

When the component W and the crystalline resin A are compatible with each other in the toner, the TmT is lower than the TmW. When the crystallinity of the component W in the toner is higher than that when the component W exists as a simple substance, the TmT may be higher than the TmW. This means that the crystallinity of the release agent is further improved by the crystalline resin A.

The lower limit of the value of “TmW−TmT” is −2.0. When the “TmW−TmT” is greater than 4.5, the compatibility between the component W and the crystalline resin A in the toner is high, and the hot-offset resistance and the bending resistance decrease.

The upper limit of the “TmW−TmT” can be 4.0 or less and may be 3.0 or less.

The “TmW−TmT” can be controlled by the type of the release agent to be used in the toner, the SP value of the crystalline resin A, and so on.

The crystalline resin A will be described. Monomers including the unit (a) or unit (a-A) that can be used in the crystalline resin A may be used alone or in combination of two or more.

The crystalline resin A can include an additional unit, in addition to the unit (a). An example of the method for introducing the additional unit to the crystalline resin A is a method of polymerizing a monomer exemplified above and an additional vinyl-based monomer.

Examples of the additional vinyl-based monomer include the followings:
Styrene, α-methylstyrene, and (meth)acrylic acid esters such as methyl (meth)acrylate, ethyl (meth)acrylate, n-butyl (meth)acrylate, t-butyl (meth)acrylate, and 2-ethylhexyl (meth)acrylate;
Monomers having a urea group: e.g., monomers in which an amine having 3 to 22 carbon atoms [primary amines (such as n-butylamine, t-butylamine, propylamine, and isopropylamine), secondary amines (such as di-n-ethylamine, di-n-propylamine, and di-n-butylamine), aniline, and cyclohexylamine] and isocyanate having 2 to 30 carbon atoms having an ethylenically unsaturated bond are reacted by a known method;
Monomers having a carboxy group: e.g., methacrylic acid, acrylic acid, and 2-carboxyethyl (meth)acrylate;
Monomers having a hydroxy group: e.g., 2-hydroxyethyl (meth)acrylate and 2-hydroxypropyl (meth)acrylate;
Monomers having an amide group: e.g., acrylamide and monomers in which an amine having 1 to 30 carbon atoms and a carboxylic acid having 2 to 30 carbon atoms having an ethylenically unsaturated bond (such as acrylic acid and methacrylic acid) are reacted by a known method;
Monomers having a nitrile group: e.g., acrylonitrile and methacrylonitrile; and
Vinyl esters: vinyl acetate, vinyl propionate, vinyl butyrate, vinyl caproate, vinyl caprylate, vinyl caprate, vinyl laurate, vinyl myristate, and vinyl palmitate.

In particular, styrene, acrylonitrile, methacrylonitrile, (meth)acrylic acid, methyl (meth)acrylate, and t-butyl (meth)acrylate can be used.

The crystalline resin A may have an SP value of 18.4 (J/cm³)^{0.5} or more and 20.5 (J/cm³)^{0.5} or less.

When the SP value of the crystalline resin A is 18.4 (J/cm³)^{0.5} or more, the compatibility with the release agent is reduced, and the bending resistance is likely to be improved. When the SP value is 20.5 (J/cm³)^{0.5} or less, the proportion of the unit (a) is high, the crystal amount is increased, and the low-temperature fixability is easily improved. The SP value range may be 19.5 (J/cm³)^{0.5} or more and 20.2 (J/cm³)^{0.5} or less.

Examples of the amorphous resin B that can be used in the present disclosure include a vinyl resin, a polyester resin, a polyurethane resin, and an epoxy resin, and a vinyl resin and a polyester resin may be used from the viewpoint of controlling the property of phase separation with respect to the crystalline resin A.

When the amorphous resin B is a vinyl resin, as the monomer unit, a vinyl-based monomer that can be used in the crystalline resin A can be used. In particular, a vinyl resin using styrene or an alkyl (meth)acrylate may be used from the same viewpoint. The monomer units may be used alone or in combination of two or more. The monomer unit may be a vinyl resin including both styrene and (meth)acrylic acid ester.

When the amorphous resin B is a copolymer including both styrene and (meth)acrylic acid ester as the monomer units, the property of phase separation with respect to the crystalline resin A is moderately maintained, and the bending resistance of the solid fixed image is likely to be improved.

When the amorphous resin B is a vinyl resin, it is also possible to include, in addition to the monomer unit above, an additional monomer unit. An example of the method for introduction of the additional monomer unit is a method of polymerizing the (meth)acrylic acid ester and a vinyl-based monomer that can be used in the crystalline resin A.

When the amorphous resin B is a polyester resin, among polyester resins that can be obtained by a reaction of a di- or higher valent polycarboxylic acid and a polyhydric alcohol, a resin that does not show crystallinity can be used.

Examples of the polycarboxylic acid include the following compounds: dibasic acids, such as succinic acid, adipic acid, sebacic acid, phthalic acid, isophthalic acid, terephthalic acid, malonic acid, and dodecenylsuccinic acid, and anhydrides and lower alkyl esters thereof; aliphatic unsaturated dicarboxylic acids, such as maleic acid, fumaric acid, itaconic acid, and citraconic acid; and 1,2,4-benzenetricarboxylic acid and 1,2,5-benzenetricarboxylic acid and anhydrides and lower alkyl esters thereof. These compounds may be used alone or in combination of two or more.

Examples of the polyhydric alcohol include the following compounds: alkylene glycol (ethylene glycol, 1,2-propylene glycol, and 1,3-propylene glycol); alkylene ether glycol (polyethylene glycol and polypropylene glycol); alicyclic diol (1,4-cyclohexane dimethanol); bisphenols (bisphenol A); and alkylene oxide (ethylene oxide and propylene oxide) adducts of alicyclic diol. The alkyl portions of the alkylene glycol and alkylene ether glycol may be linear or branched. The examples further include glycerin, trimethylol ethane, trimethylol propane, and pentaerythritol. These compounds may be used alone or in combination of two or more.

In the purpose of adjusting the acid value or hydroxyl value, a monovalent acid, such as acetic acid and benzoic acid, or a monovalent alcohol, such as cyclohexanol and benzyl alcohol, can also be used as needed.

The method for manufacturing the polyester resin is not particularly limited, and, for example, a transesterification method and a direct polycondensation method can be used alone or in combination.

As the amorphous resin B, one resin may be used alone, or a combination of two or more resins may be used.

The amorphous resin B may have an SP value of 18.9 (J/cm³)^{0.5} or more and 21.4 (J/cm³)^{0.5} or less.

When the SP value of the amorphous resin B is 18.9 (J/cm³)^{0.5} or more, the amorphous resin B easily becomes a domain in the toner, the density of the crystalline resin A increases, and low-temperature fixability is easily achieved. When the SP value is 21.4 (J/cm³)^{0.5} or less, the property of phase separation with respect to the crystalline resin A is easily moderately maintained, the interface between resins is reduced, and the bending resistance of the solid fixed image is likely to be improved. The SP value may be 19.5 (J/cm³)^{0.5} or more and 20.2 (J/cm³)^{0.5} or less.

The peak molecular weight Mp of the component W by GPC may be 1000 or more and 3000 or less. When the Mp is 1000 or more, the mold releasing effect during high-temperature fixing is high, and the hot-offset resistance is likely to be improved. When the Mp is 3000 or less, the mold releasing effect during low-temperature fixing is high, and the low-temperature fixability is likely to be improved.

The component W may have an SP value of 16.5 (J/cm³)^{0.5} or more and 17.6 (J/cm³)^{0.5} or less.

When the SP value of the component W is 16.5 (J/cm³)^{0.5} or more, the releasability is easily secured, and the low-temperature fixability and the bending resistance are likely to be improved. When the SP value is 17.6 (J/cm³)^{0.5} or less, compatibility with the crystalline resin A deteriorates, and the bending resistance is likely to be improved.

The release agent that can be used as the component W is at least one selected from the group consisting of hydrocarbon wax, ester wax, and silicone wax. Effective releasability can be easily secured by using hydrocarbon wax, ester wax, or silicone wax.

The hydrocarbon wax is not particularly limited, and examples thereof include the followings:
Aliphatic hydrocarbon wax: low-molecular-weight polyethylene, low-molecular-weight polypropylene, low-molecular-weight olefin copolymer, Fischer-Tropsch wax, poly-α-olefin, and wax obtained by oxidation or acid-addition thereof.

The ester wax may be natural ester wax or synthesized ester wax as long as at least one ester bond exists in one molecule.

The ester wax is not particularly limited, and examples thereof include the followings:
Esters of a monovalent alcohol and a monocarboxylic acid, such as behenyl behenate, stearyl stearate, and palmityl palmitate;
Esters of a divalent carboxylic acid and a monoalcohol, such as dibehenyl sebacate;
Esters a divalent alcohol and a monocarboxylic acid, such as ethylene glycol distearate and hexanediol dibehenate;
Esters of a trivalent alcohol and a monocarboxylic acid, such as glycerin tribehenate;
Esters of a tetravalent alcohol and a monocarboxylic acid, such as pentaerythritol tetrastearate and pentaerythritol tetrapalmitate;
Esters of a hexavalent alcohol and a monocarboxylic acid, such as dipentaerythritol hexastearate, dipentaerythritol hexapalmitate, and dipentaerythritol hexabehenate;
Esters of a polyfunctional alcohol and a monocarboxylic acid, such as polyglycerin behenate; and
Natural ester wax, such as Carnauba wax and rice wax.

In particular, the ester wax may be an ester a hexavalent alcohol and a monocarboxylic acid, such as dipentaerythritol hexastearate, dipentaerythritol hexapalmitate, and dipentaerythritol hexabehenate.

The silicone wax may have at least one siloxane bond and at least one alkylene group having 13 to 40 carbon atoms in one molecule. Examples thereof include an alkyl group-containing modified dimethicone (dimethylpolysiloxane) and a dimethicone-containing copolymer.

The component W may have a structure of a formula (2). The component W having a structure of the formula (2) can easily control the “TmW−TmT”. In particular, X₁ and Y₁ representing poly-α-olefin may be a combination described by (ii) below.

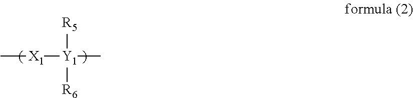

[in the formula (2),
R₅ represents a hydrogen atom or a methyl group,
R₆ represents a linear alkyl group having 14 to 34 carbon atoms, and
X₁ and Y₁ are any of the following combinations (i) and (ii):
(i) X₁ represents an oxygen atom, and Y₁ represents a silicon atom; and
(ii) X₁ represents a methylene group, and Y₁ represents a carbon atom].

As the release agent, hydrocarbon wax, ester wax, or silicone wax may be used alone. Alternatively, hydrocarbon wax, ester wax, and silicone wax may be used in combination, or a mixture of two or more types of each wax may be used. Storage elastic modulus and ratio of storage elastic modulus to loss elastic modulus

In measurement of the viscoelasticity of a toner, when the temperature at which the storage elastic modulus G′ is 1.0×10⁷ Pa is designated as T1 [° C.], the toner of the present disclosure may satisfy the following expression (7):

50.0≤T1≤70.0 (7).

Both the low-temperature fixability of the toner and the suppression of fogging after leaving can be achieved by satisfying the expression (7).

When the T1 is 50.0° C. or more, the suppression of fogging after leaving is enhanced. In contrast, when the T1 is 70.0° C. or less, the low-temperature fixability is improved.

The T1 can be controlled by, for example, the length of the long-chain alkyl group of the crystalline resin A and the proportion of the long-chain alkyl group in the binder resin.

In the measurement of the viscoelasticity of a toner, when the ratios (tan δ) of the loss elastic modulus G″ to the storage elastic modulus G′ at the temperature T1 [° C.] and the temperature T1-10 [° C.] are designated as tan δ (T1) and tan δ (T1-10), respectively, the toner of the present disclosure may satisfy the following expressions (8) and (9):

0.30≤tan δ (T1)≤1.00 expression (8); and

1.00≤tan δ (T1)/tan δ (T1-10)≤1.90 expression (9).

Since the T1 is the temperature during the toner is melting, when the tan δ (T1) is within the range of the expression (8), the easiness of deformation during low-temperature fixing is moderately maintained, and even when the transfer material has rough texture, such as rough paper, high gloss is likely to be maintained on the rough paper. When the “tan δ (T1)/tan δ (T1-10)” is within the range of the expression (9), the easiness of deformation in the protruded portions and depressed portions of rough paper is within a certain range, and gloss uniformity is likely to be improved. The lower limit of tan δ (T1) may be 0.40 or more. The upper limit of tan δ (T1) may be 0.90 or less or 0.80 or less.

The tan δ (T1) can be controlled by, for example, the amount of the resin in the toner and also can be controlled by, for example, the length of the long-chain alkyl group of the crystalline resin A and the proportion of the long-chain alkyl group in the binder resin. Furthermore, the tan δ (T1) also can be controlled by the type and addition amount of the crosslinking agent during the manufacturing of the toner.

The lower limit of the tan δ (T1)/tan δ (T1-10) can be 1.10 or more and may be 1.20 or more. The upper limit may be 1.80 or less.

The tan δ (T1)/tan δ (T1-10) can be controlled by, for example, the type and addition amount of the polymerizable monomer to be used in the toner.

### Toner

The toner particle may have a weight average particle diameter D4 of 4.00 μm or more and 15.00 μm or less or 5.00 μm or more and 8.00 μm or less. When the weight average particle diameter (D4) is within the above range, the bending resistance is likely to be improved.

In the toner of the present disclosure, the tetrahydrofuran (THF)-soluble matter may have a weight average molecular weight (Mw) of 10000 or more and 200000 or less measured by gel permeation chromatography (GPC). The lower limit can be 30000 or more and may be 50000 or more. The upper limit may be 180000 or less. When the Mw is within the above range, the durability of the toner is likely to be improved.

### Colorant

The toner of the present disclosure may contain a colorant. Examples of the colorant include known organic pigments, organic dyes, inorganic pigments, carbon black as a black colorant, and magnetic particles.

Examples of yellow colorant includes the followings: condensed azo compounds, isoindolinone compounds, anthraquinone compounds, azo metal complexes, methine compounds, and arylamide compounds. Specifically, C.I. Pigment Yellow 12, 13, 14, 15, 17, 62, 74, 83, 93, 94, 95, 109, 110, 111, 128, 129, 147, 155, 168, and 180 can be used.

Examples of magenta colorant include the followings: condensed azo compounds, diketopyrrolopyrrole compounds, anthraquinone compounds, quinacridone compounds, basic dye lake compounds, naphthol compounds, benzimidazolone compounds, thioindigo compounds, and perylene compounds. Specifically, C.I. Pigment Red 2, 3, 5, 6, 7, 23, 48:2, 48:3, 48:4, 57:1, 81:1, 122, 144, 146, 166, 169, 177, 184, 185, 202, 206, 220, 221, and 254 can be used.

Examples of cyan colorants include the followings: copper phthalocyanine compounds and derivatives thereof, anthraquinone compounds, and basic dye lake compounds. Specifically, C.I. Pigment Blue 1, 7, 15, 15:1, 15:2, 15:3, 15:4, 60, 62, and 66 can be used.

The colorant is selected from the viewpoint of hue angle, color saturation, lightness value, light fastness, and dispersibility in the toner.

The content of the colorant may be 1.0 parts by mass or more and 20.0 parts by mass or less with respect to 100.0 parts by mass of the binder resin. When a magnetic particle is used as the colorant, the content thereof may be 40.0 parts by mass or more and 150.0 parts by mass or less with respect to 100.0 parts by mass of the binder resin.

### Charge Control Agent

The toner particle may contain a charge control agent as needed. The charge control agent may be externally added to the toner particle. It is possible to stabilize the charge characteristics and control the optimum triboelectric charge quantity according to the development system by mixing the charge control agent.

As the charge control agent, a known charge control agent can be used. In particular, the charge control agent may be a charge control agent that has a high charging speed and can stably maintain a certain amount of charge.

As the charge control agent that controls the toner to a negative charge, organic metal compounds and chelate compounds are effective, and examples thereof include monoazo metal compounds, acetylacetone metal compounds, aromatic oxycarboxylic acid, aromatic dicarboxylic acid, oxycarboxylic acid, and dicarboxylic acid-based metal compounds.

Examples of the charge control agent that controls the toner to a positive charge include the followings: nigrosine, quaternary ammonium salts, metal salts of higher fatty acids, diorganotin borates, guanidine components, and imidazole compounds.

The content of the charge control agent can be 0.01 parts by mass or more and 20.0 parts by mass or less with respect to 100.0 parts by mass of the toner particle and may be 0.5 parts by mass or more and 10.0 parts by mass or less.

### External Additive

The toner particle may be used directly as a toner or may be mixed with an external additive and so on as needed so that the external additive adheres to the surface of the toner particle as a toner.

Examples of the external additive include inorganic microparticles selected from the group consisting of silica microparticles and alumina microparticles and complex oxides thereof. Examples of the complex oxide include silica aluminum microparticles and strontium titanate microparticles.

The content of the external additive can be 0.01 parts by mass or more and 8.0 parts by mass or less with respect to 100 parts by mass of the toner particle and may be 0.1 parts by mass or more and 4.0 parts by mass or less.

### Manufacturing Method of Toner

The toner particle of the present disclosure can be manufactured by any known method, such as suspension polymerization, emulsion aggregation, dissolution suspension, or pulverization, within the scope of the present configuration, and may be manufactured by manufactured by suspension polymerization.

The suspension polymerization will be described in detail.

For example, a crystalline resin A synthesized in advance and a release agent are added to a mixture of polymerizable monomers to generate the amorphous resin B of the present disclosure. Other materials such as a colorant and a charge control agent are added thereto as needed, followed by dissolving or dispersing uniformly to prepare a polymerizable monomer composition.

Subsequently, the polymerizable monomer composition is dispersed in an aqueous medium with a stirrer or the like to prepare a suspended particle of the polymerizable monomer composition. Subsequently, the polymerizable monomer contained in the particle is polymerized with a polymerization initiator or the like to obtain a toner particle.

After the completion of the polymerization, the toner particle may be subjected to filtration, washing, and drying by known methods, and an external additive may be added thereto as needed to obtain a toner.

As the polymerization initiator, a known polymerization initiator can be used.

Examples of the polymerization initiator include azo- or diazo-based polymerization initiators such as 2,2′-azobis-(2,4-dimethylvaleronitrile), 2,2′-azobisisobutyronitrile, 1,1′-azobis(cyclohexane-1-carbonitrile), 2,2′-azobis-4-methoxy-2,4-dimethylvaleronitrile, and azobisisobutyronitrile; and peroxide polymerization initiators such as benzoyl peroxide, t-butyl peroxy-2-ethylhexanoate, t-butyl peroxypivalate, t-butyl peroxyisobutyrate, t-butyl peroxyneodecanoate, methyl ethyl ketone peroxide, diisoproyl peroxycarbonate, cumene hydroperoxide, 2,4-dichlorobenzoyl peroxide, and lauroyl peroxide.

In addition, a known chain transfer agent or a polymerization inhibitor may be used.

The aqueous medium may contain an inorganic or organic dispersion stabilizer.

As the dispersion stabilizer, a known dispersion stabilizer can be used.

Examples of the inorganic dispersion stabilizer include phosphates such as hydroxyapatite, tricalcium phosphate, dibasic calcium phosphate, magnesium phosphate, aluminum phosphate, and zinc phosphate; carbonates such as calcium carbonate and magnesium carbonate; metal hydroxides such as calcium hydroxide, magnesium hydroxide, and aluminum hydroxide; sulfates such as calcium sulfate and barium sulfate; calcium metasilicate; bentonite; silica; and alumina.

Examples of the organic dispersion stabilizer include polyvinyl alcohol, gelatin, methyl cellulose, methylhydroxypropyl cellulose, ethyl cellulose, a sodium salt of carboxymethyl cellulose, polyacrylic acid and a salt thereof, and starch.

When an inorganic compound is used as the dispersion stabilizer, although a commercially available one may be used directly, the inorganic compound may be generated in an aqueous medium and used in order to obtain more fine particles.

For example, in the case of hydroxyapatite or calcium phosphate such as tricalcium phosphate, a phosphate aqueous solution and a calcium salt aqueous solution may be mixed under high stirring.

The aqueous medium may contain a surfactant. As the surfactant, a known surfactant can be used, and examples thereof include anionic surfactants such as dodecylbenzene sodium sulfate and sodium oleate; cationic surfactants; amphoteric surfactants; and nonionic surfactants.

### Measurement Method of Each Physical Property Value

The calculation method or measurement method for physical properties of a toner and toner materials will now be described.

### Method for Measuring Peak Temperature of Endothermic Peak

The peak temperature of an endothermic peak is measured using DSC Q2000 (manufactured by TA Instruments, Inc.) under the following conditions:
Temperature increase rate: 10° C./min,
Measurement start temperature: 20° C., and
Measurement end temperature: 180° C.

The temperature of an apparatus detecting unit is corrected using the melting points of indium and zinc, and the heat quantity is corrected using the heat of fusion of indium.

Specifically, 5 mg of a sample is precisely weighed and is placed in an aluminum pan and subjected to differential scanning calorimetry. As a reference, a vacant aluminum pan is used. As a temperature increase process, the temperature is raised to 180° C. at a rate of 10° C./min. Then, the peak temperature is calculated from each peak.

The maximum endothermic peak of the component W is measured by modifying the conditions as follows:
Temperature increase rate: 10° C./min,
Temperature decrease rate: 10° C./min,
Measurement start temperature: 20° C.,
First temperature increase end temperature: 180° C.,
Temperature decrease end temperature: 20° C., and
Second temperature increase end temperature: 180° C.
   As the first temperature increase process, the temperature is raised to 180° C. at a rate of 10° C./min. Subsequently, the temperature is decreased to 20° C., and as the second temperature increase process, the temperature is raised to 180° C. at a rate of 10° C./min.
   The peak temperature is calculated from the peak detected in the second temperature increase process. Other conditions are the same as above.

### Method for Measuring Weight Average Particle Diameter (D4)

The weight average particle diameter (D4) of a toner particle is measured using a precision particle size distribution measuring apparatus (trade name: Coulter Counter Multisizer 3, manufactured by Beckman Coulter, Inc.) equipped with a 100-μm aperture tube for an aperture impedance method and using attached dedicated software (trade name: Beckman Coulter Multisizer 3, Version 3.51, manufactured by Beckman Coulter, Inc.) for setting measurement conditions and measurement data analysis at 25000 effective measuring channels, and measurement data are analyzed to calculate the weight average particle diameter (D4).

The electric aqueous solution that is used in measurement is that obtained by dissolving special grade sodium chloride in deionized water at a concentration of about 1 mass %. For example, ISOTONII (trade name) manufactured by Beckman Coulter, Inc. can be used.

Before the measurement and analysis are performed, the dedicated software is set as follows.

In the “screen of changing standard method of measurement (SOM)” of the dedicated software, the number of total counts of the control mode is set to 50000 particles, the number of measurements is set to 1, and as the Kd value, the value obtained using “standard particle 10.0 μm” (manufactured by Beckman Coulter, Inc.) is set. The measurement button of threshold/noise level is pushed to automatically set the threshold and noise levels. The current is set to 1600 μA, the gain is set to 2, the electrolyte solution is set to ISOTONII (trade name), and the flush of the aperture tube after measurement is checked off.

In the “screen of setting conversion from pulse to particle diameter” of the dedicated software, the bin interval is set to logarithmic particle diameter, the particle diameter bin is set to 256 particle diameter bin, and the particle diameter range is set to from 2 μm to 60 μm.

A specific measuring method is as follows:
(1) About 200 ml of the electric aqueous solution is put in a 250-mL glass round bottom beaker dedicated to Multisizer 3, the beaker is set to a sample stand, and stirring with a stirrer rod is performed at 24 rotations/sec in the counterclockwise direction. Soiling and air bubbles in the aperture tube are removed by the “flush of aperture tube” function of the dedicated software;
(2) About 30 mL of the electric aqueous solution is put in a 100-mL glass flat bottom beaker. Then, about 0.3 mL of a diluted solution of Contaminon N (trade name) manufactured by FUJIFILM Wako Pure Chemical Corporation diluted 3 times by mass with deionized water is added thereto as a dispersant. Contaminon N (trade name) is a 10 mass % aqueous solution of neutral detergent for cleaning precise measurement devices, consisting of a nonionic surfactant, an anionic surfactant, and an organic builder and having a pH 7;
(3) A predetermined amount of deionized water is put in the water bath of an ultrasonic disperser (trade name: Ultrasonic Dispersion System Tetora 150, manufactured by Nikkaki Bios Co., Ltd.), and about 2 mL of Contaminon N (trade name) is added to this water bath. Ultrasonic Dispersion System Tetora 150 is an ultrasonic disperser includes two built-in oscillators having an oscillating frequency of 50 kHz with phases shifted by 180 degrees from each other, and has an electrical output of 120 W;
(4) The beaker of the above (2) is set to the beaker-fixing hole of the ultrasonic disperser, and the ultrasonic disperser is operated. The height position of the beaker is adjusted such that the resonant state of the liquid surface of the electric aqueous solution in the beaker is the maximum;
(5) About 10 mg of a toner particle is added little by little to the electric aqueous solution while irradiating the electric aqueous solution in the beaker of the above (4) with ultrasonic waves and is dispersed. The ultrasonic dispersion process is continued for further 60 seconds. In the ultrasonic dispersion, the water temperature is appropriately adjusted such that the water temperature of the water bath is 10° C. to 40° C.;
(6) The electric aqueous solution of the above (5) in which the toner particle is dispersed is dropped using a pipette in the round bottom beaker of the above (1) installed inside the sample stand, and the measurement concentration is adjusted to about 5%. The measurement is performed until the number of measurement particles reaches 50000; and
(7) The measurement data are analyzed with the dedicated software attached to the apparatus to calculate the weight average particle diameter (D4). The “arithmetic diameter” of analysis/volume statistic value (arithmetic average) screen when graph/volume % is set by the dedicated software is the weight average particle diameter (D4).

### Method for Measuring Molecular Weight

The molecular weight (weight average molecular weight Mw) of the tetrahydrofuran-soluble matter of each of the toner, crystalline resin A, amorphous resin B, and component W was measured by gel permeation chromatography (GPC) as follows.

A sample is dissolved in tetrahydrofuran (THF) at 60° C. for 24 hours. The obtained solution is filtered through a solvent-resistant membrane filter with a pore diameter of 0.2 μm “Maishori Disk” (manufactured by Tosoh Corporation) to obtain a sample solution. The sample solution is adjusted so that the concentration of a component that is soluble in THF is 0.8 mass %. This sample solution is subjected to measurement under the following conditions:
Apparatus: HLC8120 GPC (detector: RI) (manufactured by Tosoh Corporation);
Column: 7 columns of Shodex KF-801, 802, 803, 804, 805, 806, and 807 (manufactured by Resonac Corporation);
Eluent: tetrahydrofuran (THF);
Flow rate: 1.0 mL/min;
Oven temperature: 40.0° C.; and
Sample injection amount: 0.10 mL.

In the calculation of the molecular weight of a sample, a molecular weight calibration curve formed using standard polystyrene resins (e.g., trade name “TSK standard polystyrene F-850, F-450, F-288, F-128, F-80, F-40, F-20, F-10, F-4, F-2, F-1, A-5000, A-2500, A-1000, and A-500”, manufactured by Tosoh Corporation) is used.

### Method for Separating Component W from Toner

In the separation of the component W from a toner, the toner is dissolved in tetrahydrofuran to obtain a tetrahydrofuran-soluble matter, the obtained tetrahydrofuran-soluble matter is dissolved in n-hexane to obtain a n-hexane-soluble matter, and the obtained n-hexane-soluble matter is subjected to gel permeation chromatography (GPC) to isolate a component having a molecular weight of 5000 or less as the component W.

The tetrahydrofuran-soluble matter of a toner is obtained by the following procedure. Five hundred milligrams of the toner is put in a cylindrical filter paper (trade name: No. 86R, size: 28×100 mm, available from Advantec Toyo Kaisha, Ltd.) and is set to a Soxhlet extractor. Extraction is performed using 200 mL of THE as a solvent for 18 hours at a reflux rate such that the solvent extraction cycle is once per about 5 minutes. After completion of the extraction, the solvent is removed by an evaporator, and vacuum drying is performed at 40° C. for 8 hours to obtain a tetrahydrofuran-soluble matter of the toner.

The n-hexane-soluble matter is obtained by the following procedure: the tetrahydrofuran-soluble matter is added to 200 mL of n-hexane and is dissolved in the n-hexane at room temperature for 24 hours. The n-hexane solution is filtered, the filtrate is extracted, the solvent is removed by an evaporator, and vacuum drying is performed at 40° C. for 8 hours to obtain a n-hexane-soluble matter.

Subsequently, the n-hexane-soluble matter is subjected to GPC (recycle HPLC) to separate a component having a molecular weight of 5000 or less as a release agent. The isolation method is shown below.

A chloroform solution of the n-hexane-soluble matter is produced. The obtained solution is filtered through a solvent-resistant membrane filter with a pore diameter of 0.2 μm “Maishori Disk” (manufactured by Tosoh Corporation) to obtain a sample solution. The sample solution is adjusted so that the concentration of a component that is soluble in chloroform is 1.0 mass %. This sample solution is subjected to GPC (recycle HPLC) under the conditions below for isolation. The obtained isolated solution is vacuum dried to obtain the component W.
Apparatus: LC-Sakura NEXT (manufactured by Japan Analytical Industry Co., Ltd.),
Column: JAIGEL2H, 4H (manufactured by Japan Analytical Industry Co., Ltd.),
Eluent: chloroform,
Flow rate: 10.0 mL/min,
Oven temperature: 40.0° C.,
Sample injection amount: 1.0 mL, and
Isolation condition: isolation of a component after the elution time when the molecular weight reaches 5000 in a molecular weight calibration curve.

In the isolation condition, a molecular weight calibration curve formed using standard polystyrene resins (trade name “TSK standard polystyrene F-850, F-450, F-288, F-128, F-80, F-40, F-20, F-10, F-4, F-2, F-1, A-5000, A-2500, A-1000, and A-500”, manufactured by Tosoh Corporation) is used.

### Method for Separating Crystalline Resin A and Amorphous Resin B from Toner

The crystalline resin A and amorphous resin B can be separated from a toner by a known method, and an example is shown below.

As a method for separating a resin component from a toner, gradient LC is used. In this analysis, separation according to the polarity, not according to the molecular weight, of the resin in the binder resin is possible.

First, in the process of separating the component W, the n-hexane-insoluble component is dissolved in chloroform. The sample is adjusted such that sample concentration is 0.1 mass %, and the solution is filtered through a PTFE filter of 0.45 μm, followed by measurement. The gradient polymer LC measurement conditions are shown below:
Apparatus: UlTIMATE3000 (manufactured by Thermo Fisher Scientific);
Mobile phase: A: chloroform (HPLC), B: acetonitrile (HPLC);
Gradient: 2 min (A/B=0/100)→25 min (A/B=100/0)
(The gradient of the mobile phase change is controlled in a straight line);
Flow rate: 1.0 mL/min;
Injection: 0.1 mass %×20 μL;
Column: Tosoh TSKgel ODS (4.6 mm φ×150 mm×5 μm);
Column temperature: 40° C.; and
Detector: Corona charged particle detector (Corona-CAD) (manufactured by Thermo Fisher Scientific).

In a graph of the time-intensity obtained by measurement, the resin component is separated into two peaks according to the polarity. The separation into two resins is possible by subsequently performing the above measurement again and performing isolation according to the time when a peak reaches the valley. The separated resins are subjected to DSC measurement, and the resin having an endothermic peak is designated as crystalline resin A, and the resin not having the peak is designated as amorphous resin B.

### Method for Measuring Content Proportion of Each Monomer Unit in Resin

The content proportion of each monomer unit in a resin is measured by ¹H-NMR under the following conditions:
Measurement apparatus: FT NMR apparatus JNM-EX400 (manufactured by JEOL Ltd.);
Measurement frequency: 400 MHz;
Pulse condition: 5.0 μs;
Frequency range: 10500 Hz;
Cumulative number: 64 times;
Measurement temperature: 30° C.; and
Sample: 50 mg of a measurement sample is put in a sample tube with an inner diameter of 5 mm, heavy chloroform (CDCl₃) is added thereto as a solvent, and the mixture is dissolved in a thermostat tank of 40° C. The obtained ¹H-NMR chart is analyzed, and the structure of each monomer unit is identified. Here, as an example, measurement of the content proportion of monomer unit (a) in the crystalline resin A will be described. In the obtained ¹H-NMR chart, a peak independent from the peaks assigned to the components of other monomer units is selected from peaks assigned to the components of the monomer unit (a), and the integral value S1 of this peak is calculated. Similarly, the integral values of other monomer units contained in the resin A are also each calculated.

When the monomer units constituting the crystalline resin A are the monomer unit (a) and another monomer unit, the content proportion of the monomer unit (a) is determined using the integral value S1 and the integral value S2 of the peak of the other monomer unit as follows, wherein n1 and n2 are the numbers of hydrogen atoms in the components to which the peaks that are focused on the respective portions are assigned.

Content proportion (mol %) of monomer unit (a)={(S1/n1)/((S1/n1)+(S2/n2))}×100.

Even when the monomer units other than the monomer unit (a) is two or more, the content proportion of the monomer unit (a) can be similarly calculated.

When a polymerizable monomer in which the component other a vinyl group does not include a hydrogen atom is used, measurement is performed using ¹³C-NMR in which the measurement nucleus is ¹³C at a single pulse mode, and calculation is performed as in ¹H-NMR. The proportion (mol %) of each monomer unit calculated by the method above is multiplied by the molecular weight of each monomer unit to convert the content proportion of each monomer unit into mass %.

Regarding the amorphous resin B, the measurement is performed by the same method.

### Method for Measuring Length of Long-Chain Alkyl Group in Component W

The measurement of the length of the long-chain alkyl group in the component W uses solid thermal decomposition GC/MS under the following measurement conditions. The number of carbon atoms of the long-chain alkyl group can be measured by measuring the mass spectrum of the components of decomposition product derived from the component W, which are generated by thermal decomposition at about 300° C., and collating the decomposition peaks with database.
Measurement condition of thermal decomposition GC/MS:
Thermal decomposition apparatus: EGA/PY-3030D (Frontier Laboratories Ltd.);
Decomposition temperature: 300° C.;
Interface temperature: 320° C.;
GC/MS apparatus: TRACE 1310 ISQ LT (Thermo Fisher Scientific);
Column: HP-5MS, length: 60 m, inner diameter: 0.25 mm, thickness: 0.25 μm;
Inlet temperature: 280° C.;
Sprit flow: 30 mL/min;
Carrier flow: 1 mL/min;
Split ratio: 30;
Oven temperature: holding at 40° C. for 5 minutes, increasing the temperature at 10° C./min, and holding at 320° C. for 20 minutes;
MS ionization: EI;
Ion source temperature: 250° C.; and
Mass Range: 25 to 800.

### Method for Identifying Component W

The component W can be identified by a known method, and an example is shown below.

When the component W is poly-α-olefin, the component W can be identified by measuring the length of the long-chain alkyl group by the above-described method for measuring the chain length of the long-chain alkyl group in the component W and determining the molecular weight of the component W by the above-described method for measuring the molecular weight.

### Method for Calculating Solubility Parameter (SP Value)

The SP values of the crystalline resin A, amorphous resin B, and component W of the present disclosure are determined by the calculation method proposed by Fedors as follows.

For example, when the SP value (J/cm³)^{0.5} of the component W is calculated, the evaporation energy (Δei) (J/mol) and molar volume (Δvi) (cm³/mol) of an atom or atomic group in the molecular structure of the identified component W are determined from the table described in “Polym. Eng. Sci., 14(2), 147-154 (1974)”, and the SP value is calculated by the following expression (8):

SPw1=(ΣΔei/ΣΔvi)^{0.5}. Expression (8):

The SP value of the resin of the present disclosure is determined according to the calculation method proposed by Fedors as follows.

The SP value of the repeating unit constituting a resin is determined as follows. Here, the repeating unit constituting a resin means a molecular structure in which the double bond of a monomer to be used for obtaining a resin by polymerization is cleaved by polymerization.

For example, when the SP value (σm) (J/cm³)^{0.5} of a repeating unit is calculated, the evaporation energy (Δei) (J/mol) and molar volume (Δvi) (cm³/mol) of an atom or atomic group in the molecular structure of the repeating unit are determined from the table described in “Polym. Eng. Sci., 14(2), 147-154 (1974)”, and the SP value is calculated by the following expression (9):

σm=(ΣΔei/ΣΔvi)^{0.5}. Expression (9):

The SP value of a resin is determined by determining the evaporation energy (Δei) and molar volume (Δvi) of each of the repeating units constituting the resin, calculating the products of the evaporation energy (Δei) and molar volume (Δvi), respectively, multiplied with the molar ratio (j) of each of the repeating units in the resin, dividing the total of the evaporation energies of each repeating unit by the total of the molar volumes, and calculated by the following expression (10):

σp={(Σj×ΣΔei)/(Σj×ΣΔvi)}^{0.5}. Expression (10):

For example, assuming that the resin is composed of two types of repeating units, X and Y, and when the composition ratios of the repeating units are designated as Wx and Wy (mass %), the molecular weights as Mx and My, the evaporation energies as Δei(X) and Δei(Y), and the molar volumes as Δvi(X) and Δvi(Y), the molar ratios (j) of each of the repeating units are Wx/Mx and Wy/My, and the SP value (σp) of this resin is shown by the following expression (11):

σp=[{(Wx/Mx)×Δei(X)+Wy/My×Δei(Y)}/{(Wx/Mx)×Δvi(X)+Wy/My×Δvi(Y)}]^{0.5}. Expression (11):

Furthermore, when two or more types of resins are mixed, the SP value (σM) of the mixture is calculated as the product of the mass composition ratio (Wi) of the mixture and the SP value (σi) of each of the resins and is shown by the following expression (12):

σM=Σ(Wi×σi). Expression (12):

### Method for Measuring tan δ

In the present disclosure, tan δ is measured using a viscoelasticity measurement apparatus (rheometer) ARES (manufactured by Rheometric Scientific). The outline of the measurement is described in ARES operation manual 902-30004 (August 1997 edition) and 902-00153 (July 1993 edition) published by Rheometric Scientific and is as follows:
Measurement jig: torsion rectangular; and
Measurement sample: a rectangular sample having a width of about 12 mm, a height of about 20 mm, and a thickness of about 2.5 mm of a toner is produced using a compression molding machine (maintaining 25 kN at ordinary temperature for 30 minutes). As the compression molding machine, 100 kN press NT-100H manufactured by NPa System Co., Ltd. is used.

The jig and sample are left to stand at ordinary temperature (23° C.) for 1 hour, and the sample is then installed to the jig. The sample is fixed such that the width, thickness, and height of the measurement portion are about 12 mm, about 2.5 mm, and 10.0 mm, respectively. The temperature is adjusted to measurement start temperature of 30° C. for 10 minutes, and the measurement is then performed by the following settings:
Measurement frequency: 6.28 rad/s;
Measurement strain setting: setting the initial value to 0.1% and performing measurement at the automatic measurement mode;
Sample expansion correction: adjustment by the automatic measurement mode;
Measurement temperature: temperature is increased from 30° C. to 150° C. at a rate of 2° C. per minute; and
Measurement interval: measure viscoelasticity every 30 seconds, i.e., every 1° C.

Data are transferred through an interface to RSI Orchesrator (control, data collection, and analysis software) (manufactured by Rheometric Scientific) that operates on Windows 2000 manufactured by Microsoft.

In the measurement data, the temperature at which the storage elastic modulus G′ is 1.0×10⁷ Pa is designated as T1 [° C.]. The ratio (tan δ) of the loss elastic modulus G″ to the storage elastic modulus G′ at temperature T1 [° C.] is designated as tan δ (T1), and the tan δ at temperature T1-10 [° C.] is designated as tan δ (T1-10).

### EXAMPLES

The present disclosure will now be described more specifically by Examples, which do not intend to limit the present disclosure in any way.

### Preparation of Crystalline Resin A1

The materials below were charged in a reaction vessel equipped with a reflux condenser tube, a stirrer, a thermometer, and a nitrogen introduction tube in a nitrogen atmosphere.
Toluene: 100.0 parts by mass;
Monomer composition: 100.0 parts by mass
   [The monomer composition is a mixture of the following monomers at the following proportions:
Behenyl acrylate (monomer (a), in the formula (1), R₁=hydrogen, L₁=ester bond, m=21): 80.0 parts by mass; and
Methacrylonitrile: 20.0 parts by mass.]; and
Polymerization initiator t-butyl peroxypivalate (manufactured by NOF Corporation: PERBUTYL PV): 0.5 parts by mass.

A polymerization reaction was performed by heating to 70° C. for 12 hours while stirring the inside of the reaction vessel at 200 rpm to obtain a solution in which a polymer of the monomer composition was dissolved in toluene. Subsequently, the temperature of the solution was decreased to 25° C., and the solution was added to 1000.0 parts by mass of methanol while stirring to precipitate the methanol-insoluble matter. The obtained methanol-insoluble matter was collected by filtration and was further washed with methanol, and vacuum drying was performed at 40° C. for 24 hours to obtain a crystalline resin A1. The physical properties of the obtained crystalline resin A1 are shown in Table 2.

### Preparation of Crystalline Resins A2 to A11

Crystalline resins A2 to A11 were prepared as in the crystalline resin A1 except that the type and addition amount of the monomer composition were changed to those shown in Table 1. The physical properties of the obtained crystalline resins A2 to A11 are shown in Table 2.

TABLE 1

| | Monomer (a) | | | Another monomer 1 | | Another monomer 2 | |
|---|---|---|---|---|---|---|---|
| | | | Addition | | Addition | | Addition |
| | | No. of | amount | | amount | | amount |
| Crystalline | | carbon | (parts by | | (parts by | | (parts by |
| resin A | Type | m | mass) | Type | mass) | Type | mass) |
| Crystalline resin A1 | Behenyl acrylate | 21 | 80.0 | Styrene | 0.0 | Methacrylonitrile | 20.0 |
| Crystalline resin A2 | Behenyl acrylate | 21 | 32.0 | Styrene | 64.0 | Methacrylonitrile | 4.0 |
| Crystalline resin A3 | Behenyl acrylate | 21 | 52.0 | Styrene | 37.0 | Methacrylonitrile | 11.0 |
| Crystalline resin A4 | Behenyl acrylate | 21 | 62.0 | Styrene | 24.0 | Methacrylonitrile | 14.0 |
| Crystalline resin A5 | Behenyl acrylate | 21 | 72.0 | Styrene | 10.0 | Methacrylonitrile | 18.0 |
| Crystalline resin A6 | Behenyl acrylate | 21 | 80.0 | Styrene | 20.0 | Methacrylonitrile | 0.0 |
| Crystalline resin A7 | Behenyl acrylate | 21 | 100.0 | Styrene | 0.0 | Methacrylonitrile | 0.0 |
| Crystalline resin A8 | Behenyl acrylate | 21 | 62.0 | Styrene | 13.0 | Methacrylonitrile | 25.0 |
| Crystalline resin A9 | Behenyl acrylate | 21 | 62.0 | Styrene | 4.0 | Methacrylonitrile | 34.0 |
| Crystalline resin A10 | Behenyl acrylate | 21 | 25.0 | Styrene | 73.0 | Methacrylonitrile | 2.0 |
| Crystalline resin A11 | Behenyl acrylate | 21 | 50.0 | Styrene | 15.0 | Acrylonitrile | 35.0 |
| Crystalline resin A12 | Stearyl acrylate | 17 | 15.0 | Styrene | 0.0 | Methacrylonitrile | 20.0 |
| | Behenyl acrylate | 21 | 65.0 | | | | |
| Crystalline resin A13 | Behenyl acrylate | 21 | 75.0 | Styrene | 0.0 | Methacrylonitrile | 20.0 |
| | Myricyl acrylate | 29 | 5.0 | | | | |

TABLE 2

| | Proportion of each monomer | | | | | |
|---|---|---|---|---|---|---|
| | unit in crystalline resin A | | | | | |
| Crystalline | | Proportion | | Proportion | | Proportion |
| resin A | Type | (mass %) | Type | (mass %) | Type | (mass %) |
| Crystalline resin A1 | Behenyl acrylate | 80.0 | Styrene | 0.0 | Methacrylonitrile | 20.0 |
| Crystalline resin A2 | Behenyl acrylate | 32.0 | Styrene | 64.0 | Methacrylonitrile | 4.0 |
| Crystalline resin A3 | Behenyl acrylate | 52.0 | Styrene | 37.0 | Methacrylonitrile | 11.0 |
| Crystalline resin A4 | Behenyl acrylate | 62.0 | Styrene | 24.0 | Methacrylonitrile | 14.0 |
| Crystalline resin A5 | Behenyl acrylate | 72.0 | Styrene | 10.0 | Methacrylonitrile | 18.0 |
| Crystalline resin A6 | Behenyl acrylate | 80.0 | Styrene | 20.0 | Methacrylonitrile | 0.0 |
| Crystalline resin A7 | Behenyl acrylate | 100.0 | Styrene | 0.0 | Methacrylonitrile | 0.0 |
| Crystalline resin A8 | Behenyl acrylate | 62.0 | Styrene | 13.0 | Methacrylonitrile | 25.0 |
| Crystalline resin A9 | Behenyl acrylate | 62.0 | Styrene | 4.0 | Methacrylonitrile | 34.0 |
| Crystalline resin A10 | Behenyl acrylate | 25.0 | Styrene | 64.0 | Methacrylonitrile | 2.0 |
| Crystalline resin A11 | Behenyl acrylate | 50.0 | Styrene | 15.0 | Acrylonitrile | 35.0 |
| Crystalline resin A12 | Stearyl acrylate | 15.0 | Styrene | 0.0 | Methacrylonitrile | 20.0 |
| | Behenyl acrylate | 65.0 | | | | |
| Crystalline resin A13 | Behenyl acrylate | 75.0 | Styrene | 0.0 | Methacrylonitrile | 20.0 |
| | Myricyl acrylate | 5.0 | | | | |

| | Proportion | | | |
|---|---|---|---|---|
| | of long- | | | Endothermic |
| | chain alkyl | | | peak |
| | unit (a) | SP value of | | temperature of |
| | in crystalline | crystalline | Mw of | crystalline |
| Crystalline | resin A | resin A | crystalline | resin A |
| resin A | (mass %) | (J/cm³)^{0.5} | resin A | (° C.) |
| Crystalline resin A1 | 80.0 | 19.7 | 25700 | 65.1 |
| Crystalline resin A2 | 32.0 | 19.7 | 25400 | 62.1 |
| Crystalline resin A3 | 52.0 | 19.7 | 24400 | 63.4 |
| Crystalline resin A4 | 62.0 | 19.7 | 25700 | 64.7 |
| Crystalline resin A5 | 72.0 | 19.7 | 25900 | 64.6 |
| Crystalline resin A6 | 80.0 | 18.6 | 23800 | 65.3 |
| Crystalline resin A7 | 100.0 | 18.2 | 25000 | 64.7 |
| Crystalline resin A8 | 62.0 | 20.1 | 23300 | 64.1 |
| Crystalline resin A9 | 62.0 | 20.8 | 25600 | 65.8 |
| Crystalline resin A10 | 25.0 | 19.7 | 26300 | 65.0 |
| Crystalline resin A11 | 50.0 | 19.7 | 23500 | 65.1 |
| Crystalline resin A12 | 80.0 | 19.7 | 25200 | 60.4 |
| Crystalline resin A13 | 80.0 | 19.7 | 25000 | 68.3 |

### Preparation of Amorphous Resin B1

The materials below were charged in a reaction vessel equipped with a reflux condenser tube, a stirrer, a thermometer, and a nitrogen introduction tube in a nitrogen atmosphere.
Toluene: 100.0 parts by mass;
Monomer composition: 100.0 parts by mass
   [The monomer composition is a mixture of the following monomers at the following proportions:
Butyl acrylate: 25.0 parts by mass; and
Styrene: 75.0 parts by mass]; and
Polymerization initiator t-butyl peroxypivalate (manufactured by NOF Corporation: PERBUTYL PV): 0.5 parts by mass.

A polymerization reaction was performed by heating to 70° C. for 12 hours while stirring the inside of the reaction vessel at 200 rpm to obtain a solution in which a polymer of the monomer composition was dissolved in toluene. Subsequently, the temperature of the solution was decreased to 25° C., and the solution was then added to 1000.0 parts by mass of methanol while stirring to precipitate the methanol-insoluble matter. The obtained methanol-insoluble matter was collected by filtration and was further washed with methanol, and vacuum drying was performed at 40° C. for 24 hours to obtain an amorphous resin B1. The amorphous resin B1 had a composition composed of 25.0 mass % of butyl acrylate and 75.0 mass % of styrene and had an Mw of 52600 and an SP value of 20.1 (J/cm³)^{0.5}.

### Manufacturing Example of Release Agent W1

### Solvents

Toluene: 100.0 parts by mass; and
1-Triacontene: 100.0 parts by mass.

The materials above and the materials below were added to a heated and dried autoclave in a hydrogen atmosphere and were polymerized at 160° C. for 130 minutes.
Triisobutylaluminum: 0.5 mmol;
(1,2′-Dimethylsilylene) (2,1′-dimethylsilylene)bis(3-trimethylsilylmethylindenyl) zirconium dichloride: 2 μmol; and
Dimethylanilinium tetrakis(pentafluorophenyl)borate: 8 μmol.

After completion of the polymerization reaction, the precipitated reaction product was separated at 25° C., washed with acetone, and then dried under heating and reduced pressure to obtain a release agent W1. The release agent W1 had a peak molecular weight of 1900, and the peak top temperature of the temperature-endothermic curve was 70.0° C.

### Manufacturing Examples of Release Agents W2 to W4, W8, and W9

Release agents W2 to W4, W8, and W9 were obtained as in the manufacturing example of the release agent W1 except that the polymerizable monomers and amounts thereof were changed as shown in Table 3. The physical properties of the obtained release agents W are shown in Table 3.

### Manufacturing Example of Release Agent W5

### Preparation of α-Olefin Mixture (α1)

A mixture of α-olefin “LINEALENE 26+” manufactured by Idemitsu Kosan Co., Ltd. was put in an eggplant flask and was distilled at 0.1 kPa with a vacuum distillation device. A fraction α-olefin mixture (α1) of which the fraction temperature is from 200° C. to 300° C. was obtained.

### Preparation of Release Agent W5

The materials below were charged in a reaction vessel equipped with a reflux condenser tube, a stirrer, a thermometer, and a nitrogen introduction tube in a nitrogen atmosphere.
Poly(methylhydrosiloxane) (number average molecular weight: 390, manufactured by Sigma-Aldrich): 15.0 parts by mass;
α-Olefin mixture (α1): 55.1 parts by mass;
Toluene: 100.0 parts by mass; and
Chloroplatinic acid: 0.0055 parts by mass.

A reaction was performed by heating to 100° C. for 6 hours while stirring the inside of the reaction vessel at 200 rpm to obtain a solution dissolved in toluene. Subsequently, the temperature of the solution was decreased to 25° C., and the solution was then added to 1000.0 parts by mass of methanol while stirring to precipitate the methanol-insoluble matter. The obtained methanol-insoluble matter was collected by filtration and was further washed with methanol, and vacuum drying was performed at 40° C. for 24 hours to obtain a release agent W5. The physical properties of the obtained release agent W5 are shown in Table 3.

### Manufacturing Example of Release Agent W6

### Preparation of Release Agent W6

The materials below were charged in a reaction vessel equipped with a reflux condenser tube, a stirrer, a thermometer, and a nitrogen introduction tube in a nitrogen atmosphere.
Poly(dimethylsiloxane), hydride terminal (number average molecular weight: 580, manufactured by Sigma-Aldrich: 15.0 parts by mass;
α-Olefin mixture (α1): 19.6 parts by mass;
Toluene: 49.3 parts by mass; and
Chloroplatinic acid: 0.0020 parts by mass.

A reaction was performed by heating to 100° C. for 6 hours while stirring the inside of the reaction vessel at 200 rpm to obtain a solution dissolved in toluene. Subsequently, the temperature of the solution was decreased to 25° C., and the solution was then added to 1000.0 parts by mass of methanol while stirring to precipitate the methanol-insoluble matter. The obtained methanol-insoluble matter was collected by filtration and was further washed with methanol, and vacuum drying was performed at 40° C. for 24 hours to obtain a release agent W6. The physical properties of the obtained release agent W6 are shown in Table 3.

### Manufacturing Example of Release Agent W7

### Preparation of Release Agent W7

The materials below were charged in a reaction vessel equipped with a reflux condenser tube, a stirrer, a thermometer, and a nitrogen introduction tube in a nitrogen atmosphere.
Poly(methylhydrosiloxane) (number average molecular weight: 390, manufactured by Sigma-Aldrich): 15.0 parts by mass;
Methyl undecylenate: 20.0 parts by mass;
Toluene: 100.0 parts by mass; and
Chloroplatinic acid: 0.0020 parts by mass.

A reaction was performed by heating to 100° C. for 6 hours while stirring the inside of the reaction vessel at 200 rpm. A hydrolysis reaction was then performed, the solvent was then removed, and vacuum drying was performed at 40° C. for 24 hours to obtain a hydrolysate 1.

Subsequently, the following materials were charged in the reaction vessel accommodating the hydrolysate 1.
Behenylamine: 28.4 parts by mass; and
Xylene: 100.0 parts by mass.

A reaction was performed by heating to 135° C. for 10 hours while stirring the inside of the reaction vessel at 200 rpm to obtain a solution dissolved in xylene. Subsequently, the temperature of the solution was decreased to 25° C., and the solution was then added to 1000.0 parts by mass of methanol while stirring to precipitate the methanol-insoluble matter. The obtained methanol-insoluble matter was collected by filtration and was further washed with methanol, followed by vacuum drying at 40° C. for 24 hours to obtain a release agent W7. The physical properties of the obtained release agent W7 are shown in Table 3.

TABLE 3

| | | Addition | | | |
|---|---|---|---|---|---|
| | | amount | | Melting | |
| Release | Polymerizable | (parts | | point | SP value |
| agent W | monomer | by mass) | Mp | (° C.) | (J/cm³)^{0.5} |
| W1 | 1-Triacontene | 100.0 | 1900 | 70.3 | 17.4 |
| W2 | 1-Octacosene | 100.0 | 1750 | 67.4 | 17.4 |
| W3 | 1-Tetracosene | 100.0 | 2120 | 74.6 | 17.4 |
| W4 | 1-Hexatriaconcene | 100.0 | 2270 | 83.1 | 17.4 |
| W5 | — | — | 2250 | 69.8 | 16.9 |
| W6 | — | — | 980 | 68.2 | 16.3 |
| W7 | — | — | 3120 | 67.2 | 18.4 |
| W8 | 1-Octatriaconcene | 100.0 | 2450 | 90.0 | 17.4 |
| W9 | 1-Triacontene | 85.0 | 3800 | 67.5 | 17.3 |
| | 1-Butene | 15.0 | | | |

### Example 1

### Manufacturing of Toner by Suspension Polymerization

### Manufacturing of Toner Particle 1

A mixture consisting of:
butyl acrylate (amorphous resin B constituting monomer): 12.1 parts by mass;
styrene (amorphous resin B constituting monomer): 36.4 parts by mass; and
colorant Pigment Blue 15:3: 6.5 parts by mass
   was prepared. The mixture was charged in an attritor (manufactured by Nippon Coke & Engineering Co., Ltd.) and was dispersed using zirconia beads of a diameter of 5 mm at 200 rpm for 2 hours to obtain a raw material dispersion liquid.

Separately, 735.0 parts by mass of deionized water and 16.0 parts by mass of trisodium phosphate (dodecahydrate) were added to a vessel equipped with a high-speed stirring apparatus Homomixer (manufactured by PRIMIX Corporation) and a thermometer and were warmed to 60° C. while stirring at 12000 rpm. A potassium chloride aqueous solution in which 9.0 parts by mass of calcium chloride (dihydrate) was dissolved in 65.0 parts by mass of deionized water was charged in the vessel, followed by stirring at 12000 rpm for 30 minutes which maintaining 60° C. The pH thereof was adjusted to 6.0 with 10% hydrochloric acid to obtain an aqueous medium in which inorganic dispersion stabilizer including hydroxyapatite was dispersed in water.

Subsequently, the raw material dispersion liquid was transferred to a vessel equipped with a stirrer and a thermometer and was warmed to 60° C. while stirring at 100 rpm. Furthermore,
crystalline resin A1: 34.0 parts by mass, and
release agent W1: 9.0 parts by mass
   were added thereto, and the mixture was stirred at 100 rpm for 30 minutes while maintaining 60° C., and 9.0 parts by mass of t-butyl peroxypivalate (manufactured by NOF Corporation: PERBUTYL PV) was then added thereto as a polymerization initiator. Stirring was performed for further 1 minute, and the resulting mixture was then added to the aqueous medium that was being stirred by the high-speed stirring apparatus at 12000 rpm. While maintaining 60° C., stirring with the high-speed stirring apparatus was continued at 12000 rpm for 20 minutes to obtain a granulated solution.

The granulated solution was transferred to a reaction vessel equipped with a reflux condenser tube, a stirrer, a thermometer, and a nitrogen introduction tube and was warmed to 70° C. while stirring at 150 rpm in a nitrogen atmosphere. Polymerization was performed at 150 rpm for 12 hours while maintaining 70° C. to obtain a toner-particle dispersion liquid.

The obtained toner-particle dispersion liquid was cooled to 45° C. while stirring at 150 rpm and was then heat-treated for 5 hours while maintaining 45° C. Subsequently, dilute hydrochloric acid was added thereto while stirring until the pH reached 1.5 to dissolve the dispersion stabilizer. The solid content was collected by filtration, sufficiently washed with deionized water, and then vacuum-dried at 30° C. for 24 hours to obtain a toner particle 1. The toner particle 1 had a weight average particle diameter (D4) of 6.54 μm.

### Preparation of Toner 1

A toner 1 was obtained by adding 2.0 parts by mass of a silica microparticle (hydrophobized by silicone oil, number average particle diameter of primary particle: 10 nm, BET specific surface area: 170 m²/g) as an external additive to 98.0 parts by mass of the toner particle 1 and mixing the mixture using an FM mixer (manufactured by Nippon Coke & Engineering Co., Ltd.) at 3000 rpm for 15 minutes. The physical properties of the obtained toner 1 are shown in Table 5.

### Examples 2 to 29 and 32 to 36

Toner particles 2 to 29 and 32 to 36 were obtained as in Example 1 except that the types and addition amounts of the crystalline resin A, polymerizable monomer (amorphous resin B constituting monomer), and release agent W to be used were changed to those shown in Table 4.

Furthermore, external addition was performed as in Example 1 to obtain toners 2 to 29 and 32 to 36. The physical properties of the toners are shown in Table 5.

### Example 30

### Production of Toner by Pulverization

Crystalline resin A1: 34.0 parts by mass
Amorphous resin B1: 48.5 parts by mass
C.I. Pigment Blue 15:3: 6.5 parts by mass
Release agent W1: 9.0 parts by mass

The materials above were pre-mixed with an FM mixer (manufactured by Nippon Coke & Engineering Co., Ltd.) and were then melted and kneaded with a biaxial kneading extruder (manufactured by Ikegai Corporation, PCM-30 model).

The obtained kneaded matter was cooled and was roughly pulverized with a hammer mill and then pulverized with a mechanical pulverizer (manufactured by Turbo Kogyo Co., Ltd., T-250). The obtained finely ground powder was classified with a multi-division classifier using Coanda effect to obtain a toner particle 30 having a weight average particle diameter (D4) of 7.16 μm.

External addition was performed as in Example 1 for the toner particle 30 to obtain a toner 30. The physical properties of the toner 30 are shown in Table 5.

### Example 31

### Manufacturing of Toner by Emulsion Aggregation

### Preparation of Crystalline Resin Dispersion Liquid

Toluene: 300.0 parts by mass
Crystalline resin A1: 100.0 parts by mass

The materials above were weighed and mixed and were dissolved at 90° C.

Separately, 5.0 parts by mass of sodium dodecylbenzenesulfonate and 10.0 parts by mass of sodium laurate were added to 700.0 parts by mass of deionized water and were heat-dissolved at 90° C. Subsequently, the toluene solution and aqueous solution above were mixed and stirred using a super-high-speed stirring apparatus T.K. Robomix (manufactured by PRIMIX Corporation) at 7000 rpm. Furthermore, emulsification was performed using a high-pressure impact disperser Nanomizer (manufactured by Yoshida Kikai Co., Ltd.) at a pressure of 200 MPa. Subsequently, toluene was removed using an evaporator, and the concentration was adjusted with deionized water to obtain a crystalline resin dispersion liquid with a crystalline resin Al microparticle concentration of 20%.

The volume distribution-based 50% particle diameter (D50) of the crystalline resin A1 microparticle was 0.41 μm when measured using a dynamic light scattering particle size analyzer Nanotrac UPA-EX150 (manufactured by Nikkiso Co., Ltd.).

### Preparation of Amorphous Resin Dispersion Liquid

Toluene: 300.0 parts by mass
Amorphous resin B1: 100.0 parts by mass

The materials above were weighed and mixed and were dissolved at 90° C.

Separately, 5.0 parts by mass of sodium dodecylbenzenesulfonate and 10.0 parts by mass of sodium laurate were added to 700.0 parts by mass of deionized water and were heat-dissolved at 90° C. Subsequently, the toluene solution and aqueous solution above were mixed and stirred using a super-high-speed stirring apparatus T.K. Robomix (manufactured by PRIMIX Corporation) at 7000 rpm. Furthermore, emulsification was performed using a high-pressure impact disperser Nanomizer (manufactured by Yoshida Kikai Co., Ltd.) at a pressure of 200 MPa. Subsequently, toluene was removed using an evaporator, and the concentration was adjusted with deionized water to obtain an amorphous resin dispersion liquid with an amorphous resin microparticle concentration of 20%.

The volume distribution-based 50% particle diameter (D50) of the amorphous resin microparticle was 0.39 μm when measured using a dynamic light scattering particle size analyzer Nanotrac UPA-EX150 (manufactured by Nikkiso Co., Ltd.).

### Preparation of Release Agent Dispersion Liquid

Release agent W1: 100.0 parts by mass
Anionic surfactant Neogen RK (manufactured by DKS Co., Ltd.): 5.0 parts by mass
Deionized water: 395.0 parts by mass

The materials above were weighed, charged in a mixing vessel equipped with a stirrer, heated to 90° C., and circulated through Clearmix W-Motion (manufactured by M Technique Co., Ltd.) to perform dispersion treatment for 60 minutes. The conditions of the dispersion treatment were as follows:
Rotor outer diameter: 3 cm;
Clearance: 0.3 mm;
Rotor rotation speed: 19000 r/min; and
Screen rotation speed: 19000 r/min.

After the dispersion treatment, cooling to 40° C. was performed under cooling treatment conditions of a rotor rotation speed of 1000 r/min, a screen rotation speed of 0 r/min, and cooling rate of 10° C./min to obtain a release agent dispersion liquid with a release agent microparticle concentration of 20%.

The volume distribution-based 50% particle diameter (D50) of the release agent microparticle was 0.14 μm when measured using a dynamic light scattering particle size analyzer Nanotrac UPA-EX150 (manufactured by Nikkiso Co., Ltd.).

### Preparation of Colorant Dispersion Liquid

C.I. Pigment Blue 15:3: 50.0 parts by mass
Anionic surfactant Neogen RK (manufactured by DKS Co., Ltd.): 7.5 parts by mass
Deionized water: 442.5 parts by mass

The materials above were weighed and mixed, dissolved, and dispersed with a high-pressure impact disperser Nanomizer (manufactured by Yoshida Kikai Co., Ltd.) for 1 hour to obtain a colorant dispersion liquid with a colorant microparticle concentration of 10%.

The volume distribution-based 50% particle diameter (D50) of the colorant microparticle was 0.20 μm when measured using a dynamic light scattering particle size analyzer Nanotrac UPA-EX150 (manufactured by Nikkiso Co., Ltd.).

### Manufacturing of Toner 31

Crystalline resin dispersion liquid: 200.0 parts by mass
Amorphous resin dispersion liquid: 300.0 parts by mass
Release agent dispersion liquid: 45.0 parts by mass
Colorant dispersion liquid: 65.0 parts by mass
Deionized water: 160.0 parts by mass

The materials above were charged in a stainless steel round bottom flask and were mixed. Subsequently, the mixture was dispersed using a homogenizer Ultra-Turrax T50 (manufactured by IKA) at 5000 rpm for 10 minute. The pH was adjusted to 3.0 with a 1.0% nitric acid aqueous solution, and the mixture solution was then heated to 58° C. in a heating water bath using a stirring blade while appropriately adjusting the rotation speed such that the mixture solution is stirred. The volume average particle diameter of the formed agglomerated particles was verified as appropriate using Coulter Multisizer 3, and when agglomerated particles having a weight average particle diameter (D4) of 6.83 μm were formed, the pH was adjusted to 9.0 with a 5% sodium hydroxide aqueous solution. Subsequently, while continuing stirring, the agglomerated particles were heated to 75° C. and were fused by maintaining 75° C. for 1 hour.

Subsequently, cooling to 45° C. and heat treatment for 5 hours were performed.

Subsequently, cooling to 25° C. and filtration and solid-liquid separation were performed, followed by washing with deionized water. After the completion of the washing, drying using a vacuum drier was performed to obtain a toner particle 31 with a weight average particle diameter (D4) of 6.65 μm.

External addition was performed as in Example 1 for the toner particle 31 to obtain a toner 31. The physical properties of the toner 31 are shown in Table 5.

### Comparative Examples 1 to 7

Comparative toner particles 1 to 7 were obtained as in Example 1 except that the types and addition amounts of the crystalline resin A, polymerizable monomer (amorphous resin B constituting monomer), and release agent to be used were changed to those shown in Table 4.

Furthermore, external addition was performed as in Example 1 to obtain comparative tones 1 to 7. The physical properties of the toners are shown in Table 5.

### Comparative Example 8

Crystalline resin A11: 65.8 parts by mass
C.I. Pigment Blue 15:3: 25.7 parts by mass
Release agent W1: 6.6 parts by mass

The materials above were pre-mixed with an FM mixer (manufactured by Nippon Coke & Engineering Co., Ltd.) and were then melted and kneaded with a biaxial kneading extruder (manufactured by Ikegai Corporation, PCM-30 model).

The obtained kneaded matter was cooled and was roughly pulverized with a hammer mill and then pulverized with a mechanical pulverizer (manufactured by Turbo Kogyo Co., Ltd., T-250). The obtained finely ground powder was classified with a multi-division classifier using Coanda effect to obtain a comparative toner particle 8 having a weight average particle diameter (D4) of 6.67 μm.

External addition was performed as in Example 1 for the comparative toner particle 8 to obtain a comparative tone 8. The physical properties of the comparative toner 8 are shown in Table 5.

TABLE 4

| | | | Binder resin | | | | | | | |
|---|---|---|---|---|---|---|---|---|---|---|
| | | | | | Polymerizable monomer | | | | | |
| | | | | | | Butyl | Lauryl | Methacry- | | |
| | | | Crystalline resin A | | Styrene | acrylate | acrylate | lonitrile | | |
| | | | | Addition | Addition | Addition | Addition | Addition | Release agent | |
| | | | | amount | amount | amount | amount | amount | | Addition |
| | Toner | | | (parts by | (parts by | (parts by | (parts by | (parts by | | amount |
| | No. | Manufacturing method | Type | mass) | mass) | mass) | mass) | mass) | Type | (part) |
| Example 1 | 1 | Suspension polymerization | A1 | 34.0 | 36.4 | 12.1 | — | — | W1 | 9.0 |
| Example 2 | 2 | Suspension polymerization | A2 | 34.0 | 36.4 | 12.1 | — | — | W1 | 9.0 |
| Example 3 | 3 | Suspension polymerization | A3 | 34.0 | 36.4 | 12.1 | — | — | W1 | 9.0 |
| Example 4 | 4 | Suspension polymerization | A4 | 34.0 | 36.4 | 12.1 | — | — | W1 | 9.0 |
| Example 5 | 5 | Suspension polymerization | A5 | 34.0 | 36.4 | 12.1 | — | — | W1 | 9.0 |
| Example 6 | 6 | Suspension polymerization | A1 | 22.0 | 45.4 | 15.1 | — | — | W1 | 9.0 |
| Example 7 | 7 | Suspension polymerization | A1 | 26.0 | 42.4 | 14.1 | — | — | W1 | 9.0 |
| Example 8 | 8 | Suspension polymerization | A1 | 41.0 | 31.1 | 10.4 | — | — | W1 | 9.0 |
| Example 9 | 9 | Suspension polymerization | A1 | 54.0 | 21.4 | 7.1 | — | — | W1 | 9.0 |
| Example 10 | 10 | Suspension polymerization | A1 | 76.0 | 4.9 | 1.6 | — | — | W1 | 9.0 |
| Example 11 | 11 | Suspension polymerization | A1 | 37.4 | 40.0 | 13.3 | — | — | W1 | 0.8 |
| Example 12 | 12 | Suspension polymerization | A1 | 36.7 | 39.3 | 13.1 | — | — | W1 | 2.5 |
| Example 13 | 13 | Suspension polymerization | A1 | 35.4 | 37.9 | 12.6 | — | — | W1 | 5.5 |
| Example 14 | 14 | Suspension polymerization | A1 | 31.7 | 34.0 | 11.3 | — | — | W1 | 14.5 |
| Example 15 | 15 | Suspension polymerization | A1 | 29.9 | 32.0 | 10.6 | — | — | W1 | 19.0 |
| Example 16 | 16 | Suspension polymerization | A1 | 34.0 | 36.4 | 12.1 | — | — | W2 | 9.0 |
| Example 17 | 17 | Suspension polymerization | A1 | 34.0 | 36.4 | 12.1 | — | — | W3 | 9.0 |
| Example 18 | 18 | Suspension polymerization | A1 | 34.0 | 36.4 | 12.1 | — | — | W4 | 9.0 |
| Example 19 | 19 | Suspension polymerization | A5 | 34.0 | 36.4 | 12.1 | — | — | W5 | 9.0 |
| Example 20 | 20 | Suspension polymerization | A6 | 34.0 | 36.4 | 12.1 | — | — | W1 | 9.0 |
| Example 21 | 21 | Suspension polymerization | A7 | 34.0 | 36.4 | 12.1 | — | — | W1 | 9.0 |
| Example 22 | 22 | Suspension polymerization | A8 | 34.0 | 36.4 | 12.1 | — | — | W1 | 9.0 |
| Example 23 | 23 | Suspension polymerization | A9 | 34.0 | 36.4 | 12.1 | — | — | W1 | 9.0 |
| Example 24 | 24 | Suspension polymerization | A1 | 34.0 | 18.2 | 6.0 | 24.3 | — | W1 | 9.0 |
| Example 25 | 25 | Suspension polymerization | A1 | 34.0 | 25.1 | 8.4 | 15.0 | — | W1 | 9.0 |
| Example 26 | 26 | Suspension polymerization | A1 | 34.0 | 33.4 | 11.1 | — | 4.0 | W1 | 9.0 |
| Example 27 | 27 | Suspension polymerization | A1 | 34.0 | 27.3 | 9.1 | — | 12.1 | W1 | 9.0 |
| Example 28 | 28 | Suspension polymerization | A1 | 34.0 | 36.4 | 12.1 | — | — | W6 | 9.0 |
| Example 29 | 29 | Suspension polymerization | A1 | 34.0 | 36.4 | 12.1 | — | — | W7 | 9.0 |
| Example 30 | 30 | Pulverization | A1 | 34.0 | 36.4 | 12.1 | — | — | W1 | 9.0 |
| Example 31 | 31 | Emulsion aggregation | A1 | 34.0 | 36.4 | 12.1 | — | — | W1 | 9.0 |
| Comparative | Compar- | Suspension polymerization | A10 | 34.0 | 36.4 | 12.1 | — | — | W1 | 9.0 |
| Example 1 | ative 1 | | | | | | | | | |
| Comparative | Compar- | Suspension polymerization | A1 | 15.0 | 50.7 | 16.8 | — | — | W1 | 9.0 |
| Example 2 | ative 2 | | | | | | | | | |
| Comparative | Compar- | Suspension polymerization | A1 | 82.0 | 0.4 | 0.1 | — | — | W1 | 9.0 |
| Example 3 | ative 3 | | | | | | | | | |
| Comparative | Compar- | Suspension polymerization | A1 | 37.5 | 40.2 | 13.4 | — | — | W1 | 0.4 |
| Example 4 | ative 4 | | | | | | | | | |
| Comparative | Compar- | Suspension polymerization | A1 | 27.4 | 29.3 | 9.8 | — | — | W1 | 25.0 |
| Example 5 | ative 5 | | | | | | | | | |
| Comparative | Compar- | Suspension polymerization | A1 | 34.0 | 36.4 | 12.1 | — | — | W8 | 9.0 |
| Example 6 | ative 6 | | | | | | | | | |
| Comparative | Compar- | Suspension polymerization | A1 | 33.7 | 43.2 | 10.8 | — | — | HNP-51 | 3.8 |
| Example 7 | ative 7 | | | | | | | | | |
| Comparative | Compar- | Pulverization | A11 | 83.2 | 36.4 | 12.1 | — | — | W9 | 8.3 |
| Example 8 | ative 8 | | | | | | | | | |

TABLE 5-1

| | | | SP | Proportion | Proportion |
|---|---|---|---|---|---|
| | | | value of | of crystalline | of amorphous |
| | | | amorphous | resin A in | of resin B in |
| | | Manufacturing | resin B | toner | toner |
| | Toner No. | method | (J/cm³)^{0.5} | (mass %) | (mass %) |
| Example 1 | 1 | Suspension polymerization | 20.1 | 34.0 | 48.5 |
| Example 2 | 2 | Suspension polymerization | 20.1 | 34.0 | 48.5 |
| Example 3 | 3 | Suspension polymerization | 20.1 | 34.0 | 48.5 |
| Example 4 | 4 | Suspension polymerization | 20.1 | 34.0 | 48.5 |
| Example 5 | 5 | Suspension polymerization | 20.1 | 34.0 | 48.5 |
| Example 6 | 6 | Suspension polymerization | 20.1 | 22.0 | 60.5 |
| Example 7 | 7 | Suspension polymerization | 20.1 | 26.0 | 56.5 |
| Example 8 | 8 | Suspension polymerization | 20.1 | 41.0 | 41.5 |
| Example 9 | 9 | Suspension polymerization | 20.1 | 54.0 | 28.5 |
| Example 10 | 10 | Suspension polymerization | 20.1 | 76.0 | 6.5 |
| Example 11 | 11 | Suspension polymerization | 20.1 | 37.4 | 53.3 |
| Example 12 | 12 | Suspension polymerization | 20.1 | 36.7 | 52.3 |
| Example 13 | 13 | Suspension polymerization | 20.1 | 35.4 | 50.6 |
| Example 14 | 14 | Suspension polymerization | 20.1 | 31.7 | 45.3 |
| Example 15 | 15 | Suspension polymerization | 20.1 | 29.9 | 42.6 |
| Example 16 | 16 | Suspension polymerization | 20.1 | 34.0 | 48.5 |
| Example 17 | 17 | Suspension polymerization | 20.1 | 34.0 | 48.5 |
| Example 18 | 18 | Suspension polymerization | 20.1 | 34.0 | 48.5 |
| Example 19 | 19 | Suspension polymerization | 20.0 | 34.0 | 48.5 |
| Example 20 | 20 | Suspension polymerization | 20.1 | 34.0 | 48.5 |
| Example 21 | 21 | Suspension polymerization | 20.1 | 34.0 | 48.5 |
| Example 22 | 22 | Suspension polymerization | 20.1 | 34.0 | 48.5 |
| Example 23 | 23 | Suspension polymerization | 20.1 | 34.0 | 48.5 |
| Example 24 | 24 | Suspension polymerization | 19.4 | 34.0 | 48.5 |
| Example 25 | 25 | Suspension polymerization | 19.6 | 34.0 | 48.5 |
| Example 26 | 26 | Suspension polymerization | 20.5 | 34.0 | 48.5 |
| Example 27 | 27 | Suspension polymerization | 21.5 | 34.0 | 48.5 |
| Example 28 | 28 | Suspension polymerization | 20.1 | 34.0 | 48.5 |
| Example 29 | 29 | Suspension polymerization | 20.1 | 34.0 | 48.5 |
| Example 30 | 30 | Pulverization | 20.0 | 34.0 | 48.5 |
| Example 31 | 31 | Emulsion aggregation | 20.0 | 34.0 | 48.5 |
| Example 32 | 32 | Suspension polymerization | 20.1 | 34.0 | 48.5 |
| Example 33 | 33 | Suspension polymerization | 20.1 | 34.0 | 48.5 |
| Example 34 | 34 | Suspension polymerization | 20.1 | 34.0 | 48.5 |
| Example 35 | 35 | Suspension polymerization | 20.1 | 40.3 | 42.2 |
| Example 36 | 36 | Suspension polymerization | 20.1 | 34.0 | 48.5 |
| Comparative | Comparative 1 | Suspension polymerization | 20.1 | 34.0 | 48.5 |
| Example 1 | | | | | |
| Comparative | Comparative 2 | Suspension polymerization | 20.1 | 15.0 | 67.5 |
| Example 2 | | | | | |
| Comparative | Comparative 3 | Suspension polymerization | 20.1 | 82.0 | 0.5 |
| Example 3 | | | | | |
| Comparative | Comparative 4 | Suspension polymerization | 20.1 | 37.5 | 53.6 |
| Example 4 | | | | | |
| Comparative | Comparative 5 | Suspension polymerization | 20.1 | 27.4 | 39.1 |
| Example 5 | | | | | |
| Comparative | Comparative 6 | Suspension polymerization | 20.1 | 34.0 | 48.5 |
| Example 6 | | | | | |
| Comparative | Comparative 7 | Suspension polymerization | 20.1 | 33.7 | 51.7 |
| Example 7 | | | | | |
| Comparative | Comparative 8 | Pulverization | — | 83.2 | 0.0 |
| Example 8 | | | | | |
| | Total | | | | |
| | proportion of | | | | |
| | crystalline | | | | Endothermal |
| | resin A | | | | peak |
| | and | | | | temperature |
| | amorphous | Proportion | | | of |
| | resin B in | of component | | Mp of | component |
| | toner | W in toner | TmW − | component | W |
| | (mass %) | (mass %) | TmT (° C.) | W | (° C.) |
| Example 1 | 82.5 | 9.0 | 1.7 | 1900 | 70.3 |
| Example 2 | 82.5 | 9.0 | 1.7 | 1900 | 70.3 |
| Example 3 | 82.5 | 9.0 | 1.6 | 1900 | 70.3 |
| Example 4 | 82.5 | 9.0 | 1.7 | 1900 | 70.3 |
| Example 5 | 82.5 | 9.0 | 1.7 | 1900 | 70.3 |
| Example 6 | 82.5 | 9.0 | 1.8 | 1900 | 70.3 |
| Example 7 | 82.5 | 9.0 | 1.7 | 1900 | 70.3 |
| Example 8 | 82.5 | 9.0 | 1.6 | 1900 | 70.3 |
| Example 9 | 82.5 | 9.0 | 2.1 | 1900 | 70.3 |
| Example 10 | 82.5 | 9.0 | 2.4 | 1900 | 70.3 |
| Example 11 | 90.7 | 0.8 | 2.3 | 1900 | 70.3 |
| Example 12 | 89.0 | 2.5 | 2.1 | 1900 | 70.3 |
| Example 13 | 86.0 | 5.5 | 1.9 | 1900 | 70.3 |
| Example 14 | 77.0 | 14.5 | 1.7 | 1900 | 70.3 |
| Example 15 | 72.5 | 19.0 | 1.7 | 1900 | 70.3 |
| Example 16 | 82.5 | 9.0 | 1.6 | 1750 | 67.4 |
| Example 17 | 82.5 | 9.0 | 1.7 | 2120 | 74.6 |
| Example 18 | 82.5 | 9.0 | 1.9 | 2270 | 83.1 |
| Example 19 | 82.5 | 9.0 | 0.7 | 2250 | 69.8 |
| Example 20 | 82.5 | 9.0 | 2.8 | 1900 | 70.3 |
| Example 21 | 82.5 | 9.0 | 4.2 | 1900 | 70.3 |
| Example 22 | 82.5 | 9.0 | 1.0 | 1900 | 70.3 |
| Example 23 | 82.5 | 9.0 | 0.1 | 1900 | 70.3 |
| Example 24 | 82.5 | 9.0 | 1.7 | 1900 | 70.3 |
| Example 25 | 82.5 | 9.0 | 1.7 | 1900 | 70.3 |
| Example 26 | 82.5 | 9.0 | 1.7 | 1900 | 70.3 |
| Example 27 | 82.5 | 9.0 | 1.7 | 1900 | 70.3 |
| Example 28 | 82.5 | 9.0 | 1.3 | 980 | 68.2 |
| Example 29 | 82.5 | 9.0 | 1.4 | 3120 | 67.2 |
| Example 30 | 82.5 | 9.0 | 1.7 | 1900 | 70.3 |
| Example 31 | 82.5 | 9.0 | 1.7 | 1900 | 70.3 |
| Example 32 | 82.5 | 9.0 | 1.6 | 1900 | 70.3 |
| Example 33 | 82.5 | 9.0 | 1.8 | 1900 | 70.3 |
| Example 34 | 82.5 | 9.0 | 1.8 | 1900 | 70.3 |
| Example 35 | 82.5 | 9.0 | 1.5 | 1900 | 70.3 |
| Example 36 | 82.5 | 9.0 | 1.7 | 1900 | 70.3 |
| Comparative | 82.5 | 9.0 | 1.6 | 1900 | 70.3 |
| Example 1 | | | | | |
| Comparative | 82.5 | 9.0 | 1.7 | 1900 | 70.3 |
| Example 2 | | | | | |
| Comparative | 82.5 | 9.0 | 2.6 | 1900 | 70.3 |
| Example 3 | | | | | |
| Comparative | 91.1 | 0.4 | 1.7 | 1900 | 70.3 |
| Example 4 | | | | | |
| Comparative | 66.5 | 25.0 | 1.6 | 1900 | 70.3 |
| Example 5 | | | | | |
| Comparative | 82.5 | 9.0 | 1.7 | 2450 | 90.0 |
| Example 6 | | | | | |
| Comparative | 85.4 | 3.8 | 5.2 | 500 | 74.2 |
| Example 7 | | | | | |
| Comparative | 83.2 | 8.3 | 2.8 | 3800 | 67.5 |
| Example 8 | | | | | |

TABLE 5-2

| | | | | | Weight average |
|---|---|---|---|---|---|
| | | | | Tanδ (T1)/ | particle diameter |
| | Mw | T1 | Tanδ | Tanδ | D4 of toner |
| Toner No. | of toner | (° C.) | (T1) | (T1-10) | (μm) |
| 1 | 98400 | 59 | 0.53 | 1.42 | 6.59 |
| 2 | 98900 | 60 | 0.34 | 1.08 | 6.92 |
| 3 | 97300 | 60 | 0.41 | 1.21 | 6.63 |
| 4 | 101100 | 59 | 0.46 | 1.33 | 6.01 |
| 5 | 88300 | 59 | 0.51 | 1.40 | 6.27 |
| 6 | 96100 | 60 | 0.42 | 1.19 | 7.40 |
| 7 | 99500 | 59 | 0.46 | 1.35 | 7.14 |
| 8 | 90700 | 59 | 0.62 | 1.50 | 6.86 |
| 9 | 100200 | 59 | 0.76 | 1.65 | 7.59 |
| 10 | 87900 | 58 | 0.95 | 1.74 | 6.57 |
| 11 | 102900 | 59 | 0.54 | 1.41 | 6.57 |
| 12 | 91300 | 59 | 0.52 | 1.43 | 7.25 |
| 13 | 93900 | 59 | 0.53 | 1.42 | 7.39 |
| 14 | 100200 | 59 | 0.52 | 1.42 | 7.05 |
| 15 | 97700 | 59 | 0.53 | 1.42 | 6.75 |
| 16 | 100800 | 59 | 0.53 | 1.42 | 7.48 |
| 17 | 95400 | 59 | 0.53 | 1.41 | 6.70 |
| 18 | 94400 | 59 | 0.54 | 1.42 | 7.52 |
| 19 | 88900 | 59 | 0.55 | 1.51 | 7.66 |
| 20 | 93900 | 59 | 0.55 | 1.50 | 6.43 |
| 21 | 102200 | 59 | 0.62 | 1.59 | 5.95 |
| 22 | 100600 | 59 | 0.45 | 1.22 | 7.62 |
| 23 | 90400 | 59 | 0.46 | 1.22 | 6.11 |
| 24 | 98200 | 59 | 0.55 | 1.98 | 7.56 |
| 25 | 85900 | 59 | 0.54 | 1.85 | 6.75 |
| 26 | 102700 | 59 | 0.54 | 1.57 | 6.53 |
| 27 | 101600 | 59 | 0.53 | 1.65 | 7.00 |
| 28 | 91900 | 59 | 0.52 | 1.43 | 7.18 |
| 29 | 109900 | 59 | 0.53 | 1.43 | 7.17 |
| 30 | 47200 | 59 | 0.52 | 1.44 | 7.21 |
| 31 | 55800 | 59 | 0.53 | 1.40 | 6.67 |
| 32 | 100600 | 55 | 0.56 | 1.36 | 7.01 |
| 33 | 95000 | 63 | 0.57 | 1.49 | 6.83 |
| 34 | 91600 | 59 | 0.25 | 1.61 | 6.51 |
| 35 | 100500 | 58 | 1.10 | 1.25 | 8.16 |
| 36 | 98000 | 59 | 0.59 | 0.95 | 6.57 |
| Comparative 1 | 98500 | 6 | 0.31 | 1.02 | 7.78 |
| Comparative 2 | 93600 | 61 | 0.35 | 1.11 | 6.66 |
| Comparative 3 | 96100 | 57 | 0.98 | 1.78 | 8.05 |
| Comparative 4 | 97200 | 59 | 0.53 | 1.43 | 6.28 |
| Comparative 5 | 97200 | 59 | 0.52 | 1.44 | 6.72 |
| Comparative 6 | 93700 | 59 | 0.53 | 1.42 | 7.06 |
| Comparative 7 | 97000 | 59 | 0.53 | 1.42 | 6.91 |
| Comparative 8 | 85900 | 59 | 0.52 | 2.75 | 6.67 |

### Method for Evaluating Toner

Each of the obtained toners was subjected to the following evaluations.

### <1> Low-Temperature Fixability

A process cartridge filled with a toner was left to stand at 25° C. and a humidity of 40% RH for 48 hours. An unfixed image of an image pattern in which 9 points of 30 mm×30 mm square images were arranged evenly across the entire transfer paper was output using LBP-712Ci (manufactured by KANON KABUSHIKI KAISHA) that was modified to work even if the fixing unit was removed. The toner bearing amount on the transfer paper was adjusted to 0.80 mg/cm², and the fixing starting temperature was evaluated. As the transfer paper, an A4 sheet with rough texture (“Proper bond paper”: 105 g/m², manufactured by Fox River) was used. The fixing unit of LBP-712Ci was removed to the outside, and as the fixing unit, an outer fixing unit that works outside the laser beam printer was used. Fixing by the outer fixing unit was performed by increasing the fixing temperature from 90° C. in 5° C. increments under the condition of a process speed of 260 mm/sec.

The fixed image was verified visually, and the low-temperature fixability was evaluated using the lowest temperature not causing cold offset as the fixing starting temperature by the following criteria. The evaluation results are shown in Table 6.

### Evaluation Criteria

A: the fixing starting temperature is 100° C. or less;
B: the fixing starting temperature is 105° C. or more and 110° C. or less;
C: the fixing starting temperature is 115° C. or more and 120° C. or less; and
D: the fixing starting temperature is 125° C. or more.

### <2> Hot-Offset Resistance

The highest temperature at which hot offset was not observed under the same conditions as those of low-temperature fixability was designated as the highest fixing temperature, and the difference between the highest fixing temperature and the lowest fixing temperature was designated as the fixable range. The evaluation criteria of the fixable range are as follows. The evaluation results are shown in Table 6.

### Evaluation Criteria

A: the fixable range is 60° C. or more;
B: the fixable range is 50° C. or more and less than 60° C.;
C: the fixable range is 40° C. or more and less than 50° C.; and
D: the fixable range is less than 40° C.

### <3> Bending Resistance

A solid image with a toner bearing amount of 0.70 mg/cm² was formed on one side of A4 plain paper for color copier and printer GF-C209 (basis weight: 209 g/cm², thickness: 212 μm, available from Canon Marketing Japan Inc.) by setting the temperature 10° C. higher than the fixing starting temperature in the evaluation in the above <1>, and the recording paper on which the solid image was formed was fold into four (right angle fold). The bending conditions were that the bent portion was moved back and forth 5 times while applying a load of 4.9 kPa with a flat weight. Subsequently, the bent image portion was rubbed back and forth 5 times with lens-cleaning paper applied with a load of 4.9 kPa, and the bent portion was evaluated visually.

Subsequently, the bent portion was photographed in 512 pixel square area using a CCD camera with a resolution of 800 pixels per inch.

The threshold was set to 60%, and the image was binarized. The region where the toner has peeled off is the white area, and the smaller the white area rate, the better the bending resistance. The evaluation results are shown in Table 6.

### Evaluation Criteria

A: the white area rate is less than 1.0%;
B: the white area rate is 1.0% or more and less than 2.0%;
C: the white area rate is 2.0% or more and less than 3.0%; and
D: the white area rate is 3.0% or more.

### <4> Evaluation of Gloss and Uneven Gloss

The fixed image at the fixing starting temperature in the evaluation of the above <1> was used. The gloss value was measured using a handy gloss meter PG-1 (manufactured by Nippon Denshoku Industries Co., Ltd.). As the measurement conditions, the light emission angle and the light reception angle were each set to 75°, and the gloss values of all image patterns arranged 9 points were measured, and the average value thereof was evaluated. The evaluation results are shown in Table 6.

### Gloss Evaluation Criteria

A: the gloss average value is 24.0% or more;
B: the gloss average value is 20.0% or more and less than 25.0%;
C: the gloss average value is 15.0% or more and less than 20.0%; and
D: the gloss average value is less than 15.0%.

The standard deviation of the measured values was evaluated as the uneven gloss. The evaluation results are shown in Table 6.

### Uneven Gloss Evaluation Criteria

A: the standard deviation of gloss is 1.00 or less;
B: the standard deviation of gloss is greater than 1.00 and 2.00 or less;
C: the standard deviation of gloss is greater than 2.00 and 3.00 or less; and
D: the standard deviation of gloss is greater than 3.00.

TABLE 6

| | | Low-temperature | | | | Bending | | | | | |
|---|---|---|---|---|---|---|---|---|---|---|---|
| | | fixability | | Hot-offset | | resistance | | | | | |
| | | Fixing | | resistance | | White | | | | | |
| | | starting | | Fixable | | area | | Gloss | | | |
| | Toner | temperature | Evaluation | range | Evaluation | rate | Evaluation | Average | Evaluation | Standard | Evaluation |
| | No. | (° C.) | rank | (° C.) | rank | (%) | rank | value | rank | deviation | rank |
| Example 1 | 1 | 100 | A | 65 | A | 0.5 | A | 25.1 | A | 0.56 | A |
| Example 2 | 2 | 120 | C | 70 | A | 0.5 | A | 20.3 | B | 0.32 | A |
| Example 3 | 3 | 115 | C | 65 | A | 0.3 | A | 20.9 | B | 0.45 | A |
| Example 4 | 4 | 110 | B | 65 | A | 0.6 | A | 24.6 | A | 0.46 | A |
| Example 5 | 5 | 105 | B | 60 | A | 0.4 | A | 25.1 | A | 0.62 | A |
| Example 6 | 6 | 120 | C | 70 | A | 0.5 | A | 22.3 | B | 0.44 | A |
| Example 7 | 7 | 115 | C | 65 | A | 0.6 | A | 24.8 | A | 0.49 | A |
| Example 8 | 8 | 100 | A | 55 | B | 0.5 | A | 26.8 | A | 0.82 | A |
| Example 9 | 9 | 95 | A | 50 | B | 1.5 | B | 27.1 | A | 0.94 | A |
| Example 10 | 10 | 90 | A | 45 | C | 2.7 | C | 28.5 | A | 1.65 | B |
| Example 11 | 11 | 100 | A | 40 | C | 0.5 | A | 25.2 | A | 0.55 | A |
| Example 12 | 12 | 100 | A | 50 | B | 0.5 | A | 25.1 | A | 0.55 | A |
| Example 13 | 13 | 100 | A | 55 | B | 0.5 | A | 24.9 | A | 0.55 | A |
| Example 14 | 14 | 95 | A | 65 | A | 1.4 | B | 25.2 | A | 0.56 | A |
| Example 15 | 15 | 95 | A | 65 | A | 2.4 | C | 25.1 | A | 0.55 | A |
| Example 16 | 16 | 105 | B | 40 | C | 0.5 | A | 24.9 | A | 0.56 | A |
| Example 17 | 17 | 110 | B | 55 | B | 0.5 | A | 25.3 | A | 0.57 | A |
| Example 18 | 18 | 120 | C | 50 | B | 0.5 | A | 24.9 | A | 0.57 | A |
| Example 19 | 19 | 110 | B | 50 | B | 1.1 | B | 25.1 | A | 0.65 | A |
| Example 20 | 20 | 100 | A | 55 | B | 1.6 | B | 25.1 | A | 0.62 | A |
| Example 21 | 21 | 100 | A | 40 | C | 2.8 | C | 26.3 | A | 0.91 | A |
| Example 22 | 22 | 105 | B | 65 | A | 0.5 | A | 22.1 | A | 0.42 | A |
| Example 23 | 23 | 110 | B | 60 | A | 0.4 | A | 21.8 | B | 0.45 | A |
| Example 24 | 24 | 105 | B | 60 | A | 0.6 | A | 25.8 | A | 2.68 | C |
| Example 25 | 25 | 100 | A | 65 | A | 0.5 | A | 25.8 | A | 1.85 | B |
| Example 26 | 26 | 100 | A | 60 | A | 0.8 | A | 25.7 | A | 1.22 | B |
| Example 27 | 27 | 95 | A | 60 | A | 1.7 | B | 25.6 | A | 0.71 | A |
| Example 28 | 28 | 100 | A | 50 | B | 1.2 | B | 25.1 | A | 0.57 | A |
| Example 29 | 29 | 115 | C | 60 | A | 1.3 | B | 25.1 | A | 0.55 | A |
| Example 30 | 30 | 100 | A | 65 | A | 0.5 | A | 25 | A | 0.58 | A |
| Example 31 | 31 | 100 | A | 65 | A | 0.5 | A | 25.1 | A | 0.56 | A |
| Example 32 | 32 | 90 | A | 65 | A | 0.5 | A | 25.2 | A | 0.56 | A |
| Example 33 | 33 | 120 | C | 70 | A | 0.5 | A | 25.1 | A | 0.57 | A |
| Example 34 | 34 | 105 | B | 40 | C | 0.6 | A | 15.2 | C | 0.71 | A |
| Example 35 | 35 | 90 | A | 70 | A | 0.4 | A | 28.9 | A | 2.85 | C |
| Example 36 | 36 | 115 | C | 70 | A | 0.6 | A | 26.2 | A | 0.62 | A |
| Comparative | Comparative 1 | 125 | D | 70 | A | 0.5 | A | 18.7 | C | 0.36 | A |
| Example 1 | | | | | | | | | | | |
| Comparative | Comparative 2 | 130 | D | 65 | A | 0.5 | A | 21.1 | B | 0.42 | A |
| Example 2 | | | | | | | | | | | |
| Comparative | Comparative 3 | 90 | A | 30 | D | 5.3 | D | 28.3 | A | 1.71 | B |
| Example 3 | | | | | | | | | | | |
| Comparative | Comparative 4 | 100 | A | 30 | D | 0.7 | A | 25.1 | A | 0.53 | A |
| Example 4 | | | | | | | | | | | |
| Comparative | Comparative 5 | 95 | A | 65 | A | 3.2 | D | 25 | A | 0.56 | A |
| Example 5 | | | | | | | | | | | |
| Comparative | Comparative 6 | 130 | D | 55 | B | 0.5 | A | 25.2 | A | 0.57 | A |
| Example 6 | | | | | | | | | | | |
| Comparative | Comparative 7 | 110 | B | 35 | D | 5.5 | D | 25 | A | 0.57 | A |
| Example 7 | | | | | | | | | | | |
| Comparative | Comparative 8 | 100 | A | 35 | D | 4.8 | D | 24.7 | A | 5.32 | D |
| Example 8 | | | | | | | | | | | |

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-189767, filed Nov. 29, 2022, which is hereby incorporated by reference herein in its entirety.

What is claimed is:

1. A toner comprising a toner particle containing a crystalline resin A, an amorphous resin B, and a release agent, wherein
the crystalline resin A contains 30.0 mass % or more of a unit (a) represented by a formula (1) below, and
the crystalline resin A is contained in an amount of 20.0 mass % or more and 80.0 mass % or less based on the mass of the toner;
the amorphous resin B is contained in an amount of 5.0 mass % or more and 80.0 mass % or less based on the mass of the toner;
the total content of the crystalline resin A and the amorphous resin B is 50.0 mass % or more based on the mass of the toner;
when the toner is dissolved in tetrahydrofuran to obtain a tetrahydrofuran-soluble matter, the obtained tetrahydrofuran-soluble matter is dissolved in n-hexane to obtain a n-hexane-soluble matter, the obtained n-hexane-soluble matter is subjected to gel permeation chromatography (GPC) to isolate a component having a molecular weight of 5000 or less, and the obtained component is designated as component W,
a content of the component W is 0.5 mass % or more and 20.0 mass % or less based on the mass of the toner; and
a peak temperature of a maximum endothermic peak of the component W is designated as TmW (° C.), and when the endothermic peak of the toner is measured, a temperature of an endothermic peak derived from the component W is designated as TmT (° C.),
the Tm W and the TmT satisfy
50.0≤TmW≤85.0, and
−2.0≤TmW−TmT≤4.5, 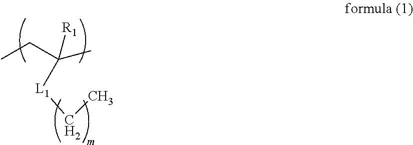
[in the formula (1), R₁ represents a hydrogen atom or a methyl group, L₁ represents a single bond, an ester bond, or an amide bond, and m represents an integer of 15 or more and 30 or less].

2. The toner according to claim 1, wherein the component W has a peak molecular weight Mp of 1000 or more and 3000 or less.

3. The toner according to claim 1, wherein the crystalline resin A contains 50.0 mass % or more and 90.0 mass % or less of the unit (a) represented by the formula (1).

4. The toner according to claim 1, wherein the crystalline resin A is contained in an amount of 25.0 mass % or more and 60.0 mass % or less based on the mass of the toner.

5. The toner according to claim 1, wherein the amorphous resin B is contained in an amount of 30.0 mass % or more and 80.0 mass % or less based on the mass of the toner.

6. The toner according to claim 1, wherein the crystalline resin A has an SP value of 18.4 (J/cm³)^{0.5} or more and 20.5 (J/cm³)^{0.5} or less.

7. The toner according to claim 1, wherein the amorphous resin B has an SP value of 18.9 (J/cm³)^{0.5} or more and 21.4 (J/cm³)^{0.5} or less.

8. The toner according to claim 1, wherein the amorphous resin B is a copolymer of styrene and a monomer including an alkyl acrylate or an alkyl methacrylate or both.

9. The toner according to claim 1, wherein the component W has an SP value of 16.5 (J/cm³)^{0.5} or more and 17.6 (J/cm³)^{0.5} or less.

10. The toner according to claim 1, wherein the component W has a unit represented by a following formula (2): 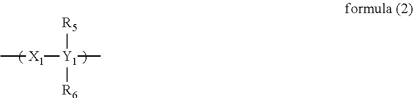
[in the formula (2),
R₅ represents a hydrogen atom or a methyl group,
R₆ represents a linear alkyl group having 14 to 34 carbon atoms,
X₁ and Y₁ are any of following combinations (i) and (ii):
(i) X₁ represents an oxygen atom, and Y₁ represents a silicon atom; and
(ii) X₁ represents a methylene group, and Y₁ represents a carbon atom].

11. The toner according to claim 10, wherein in the formula (2), X₁ is a methylene group, and Y₁ is a carbon atom.

12. The toner according to claim 1, wherein
in measurement of viscoelasticity of the toner, when a temperature at which a storage elastic modulus G′ is 1.0×10⁷ Pa is designated as T1 [° C.], a ratio (tan δ) of a loss elastic modulus G″ to a storage elastic modulus G′ at the temperature T1 [° C.] is designated as tan δ (T1), and a ratio (tan δ) at a temperature T1-10 [° C.] is designated as tan δ (T1-10), following expressions (7) to (9) are satisfied:
50.0≤T1≤70.0 (7);
0.30≤tan δ (T1)≤1.00 (8); and
1.00≤tan δ (T1)/tan δ(T1-10)≤1.90 (9).
